(19) United States
(12) Patent Application Publication
(10) Pub. No.: US 2024/0378332 A1
(43) Pub. Date: Nov. 14, 2024

(54) DYNAMIC CONDUIT DESIGN GENERATION SYSTEM AND METHOD

(71) Applicant: EE Design Tools, LLC, McKinney, TX (US)

(72) Inventor: Richard Butts, JR., McKinney, TX (US)

(73) Assignee: EE Design Tools, LLC, McKinney, TX (US)

(21) Appl. No.: 18/622,192

(22) Filed: Mar. 29, 2024

Related U.S. Application Data
(63) Continuation-in-part of application No. 18/144,553, filed on May 8, 2023, now abandoned.

(51) Int. Cl. G06F 30/13

(52) U.S. Cl. CPC G06F 30/13

(57) ABSTRACT

A conduit design generation system is disclosed. The system may include a transceiver configured to receive user inputs via a system user interface. The system may further include a processor configured to render the system user interface on a user device, and cause the system user interface to display a message requesting the user to perform a predefined action. The processor may further obtain first start and end locations associated with first cable, and generate a first conduit system model configured to house the first cable based on the first start and end locations. The processor may further obtain second start and end locations associated with second cable, and generate a second conduit system model configured to house the first and second cables based on the first and second start and end locations. The processor may further cause the system user interface to display the second conduit system model.

### CROSS-REFERENCE TO RELATED APPLICATIONS

The present application claims priority to, the benefit of, and is a continuation-in-part of U.S. patent application Ser. No. 18/144,553, filed on May 8, 2023, which is hereby incorporated by reference herein in its entirety.

### TECHNICAL FIELD

The present disclosure relates to an electrical installation project planning system and method, and more particularly to a dynamic conduit design generation system and method for facilitating a user in building an electrical installation model based on user requirements and the National Electrical Code (NEC), and for optimizing conduit installation in an under-construction building.

### BACKGROUND

Electrical engineers or contractors typically build an electrical installation model while planning to install electrical components in a building or a manufacturing plant. For example, an electrical contractor tasked with installing loads in an under-construction building (such as industrial, commercial or residential building) may build an electrical installation model. The electrical installation model may include details of loads such as motors, lights, heaters, etc. that may be required to be installed in the building. The electrical installation model may further include details of a plurality of equipment, such as cables, circuit breakers, fuse, switchgear, conduits, etc. that may be required to be installed in the building along with the loads.

For building the electrical installation model, the electrical contractor may be required to perform tedious calculations manually to estimate count, size and specification of each equipment to be installed in the building based on count, size and specification of the loads. Performing these calculations may be cumbersome for the electrical contractor as the building may have a substantial count of loads, and hence may require a substantial count (e.g., hundreds or thousands) of different types of equipment. Further, there may be instances where the electrical contractor may not take into account safety standards while performing the calculations. This may cause safety concern for building owner and/or building occupants.

Furthermore, the electrical contractor may be required to manually prepare bill of material or schedule for each equipment separately, so that equipment suppliers or vendors may provide quotes or bids to supply the equipment. Preparing the bill of material or schedule for each equipment separately may be a time consuming process, and may hence cause inconvenience to the electrical contractor.

In addition, it is known that performing calculations for raceways, e.g., conduits, required to be installed in a building is particularly challenging. For example, a conduit segment may house a single cable from a cable start point to a cable end point. However, the same conduit segment may also house one or more additional cables if the cables share the same cable start point and/or the cable end point. Therefore, it may become challenging for the electrical contractor to estimate the exact counts of conduits required to be procured and installed in the building, especially if the building is large and is expected to include hundreds or thousands of cables.

Thus, there is a need for system and method to facilitate the electrical contractor in building the electrical installation model or a conduit design model efficiently that makes it easier to perform conduit estimations/calculations, and preparing bill of material or schedule for electrical equipment conveniently.

It is with respect to these and other considerations that the disclosure made herein is presented.

### BRIEF DESCRIPTION OF THE DRAWINGS

The detailed description is set forth with reference to the accompanying drawings. The use of the same reference numerals may indicate similar or identical items. Various embodiments may utilize elements and/or components other than those illustrated in the drawings, and some elements and/or components may not be present in various embodiments. Elements and/or components in the figures are not necessarily drawn to scale. Throughout this disclosure, depending on the context, singular and plural terminology may be used interchangeably.

FIG. 1 depicts an example environment in which techniques and structures for providing the systems and methods disclosed herein may be implemented.

FIG. 2 depicts a block diagram of an example electrical installation project planning system or a conduit design generation system in accordance with the present disclosure.

FIG. 3 depicts a first example snapshot of a user interface of the electrical installation project planning system of FIG. 2 in accordance with the present disclosure.

FIG. 4 depicts a second example snapshot of the user interface of the electrical installation project planning system of FIG. 2 in accordance with the present disclosure.

FIG. 5 depicts an example schedule of equipment in accordance with the present disclosure.

FIG. 6 depicts a flow diagram of an example method to facilitate a user in building an electrical installation model in accordance with the present disclosure.

FIG. 7 depicts an example cable input form rendered on a system user interface in accordance with the present disclosure.

FIG. 8 depicts a view of an example cable summary report rendered on a system user interface in accordance with the present disclosure.

FIG. 9 depicts an example conduit creation form rendered on a system user interface in accordance with the present disclosure.

FIG. 10 depicts an example conduit summary report rendered on a system user interface in accordance with the present disclosure.

FIG. 11 depicts an example cable insertion form for a conduit rendered on a system user interface in accordance with the present disclosure.

FIGS. 12A, 12B, 12C, 12D, 12E and 12F depict a plurality of example conduit system schematic diagrams in accordance with the present disclosure.

FIG. 13 depicts an example riser diagram rendered on a system user interface in accordance with the present disclosure.

FIG. 14 depicts a flow diagram of an example conduit design generation method in accordance with the present disclosure.

### DETAILED DESCRIPTION

### Overview

The present disclosure describes system and method to facilitate a user in installing a plurality of electrical loads and equipment (e.g., cables, conduits, cable trays, etc.) in a building. Specifically, the system facilities the user in building an electrical installation model or a conduit system model by which the user may identify equipment count, sizes, specifications, etc. that may be used in the building and automatically generate bill of material/schedule. The system may receive load characteristics and load attributes associated with the plurality of loads that the user may desire to install in the building from a user device. The plurality of loads may include, for example, motors, heaters, light fixtures, etc. The load characteristics may include, for example, load count, load size, and/or the like. The load attributes may include, for example, required physical location of each load in the building, distance of each load from one or more power sources, and/or the like. The system may additionally receive equipment attributes associated with the plurality of equipment that may be installed in the building from the user device. The plurality of equipment may include, for example, cables, conduits, fuse, cable trays, raceways, etc. The equipment attributes may include, for example, required physical location of equipment in the building, information associated with whether the equipment is to be mounted on a wall or to be disposed inside the wall in the building 110, equipment manufacturer part number(s), information associated with whether single or multi-conductor cables are to be included in one assembly (if the equipment are cables), etc.

Responsive to receiving the load characteristics, the load attributes and the equipment attributes, the system may fetch information associated with an electrical standard code, for example, the National Electrical Code (NEC), from a system memory or an external server. The system may further correlate the received load characteristics, the load attributes, the equipment attributes and the information associated with the electrical standard code. In some aspects, the system may identify one or more sections of the electrical standard code that may be applicable for each load and equipment to be installed in the building based on the correlation.

Responsive to performing the correlation, the system may calculate equipment characteristics for the plurality of equipment that may be installed in the building. The equipment characteristics may include, for example, count, size, specification, etc. of each equipment. The system may further transmit the calculated equipment characteristics to the user device, so that the user may plan the equipment procurement and installation according to the equipment characteristics.

In further aspects, the system may recommend one or more additional or intermediary equipment that the user may install in the building based on the received load and equipment characteristics and attributes, and the electrical standard code. For example, the system may determine if the user has not selected and provided attributes of one or more equipment that should be installed in the building according to the electrical standard code, based on the correlation. Responsive to identifying such equipment, the system may recommend the user to provide equipment attributes and install the equipment in the building, to ensure electrical installation safety.

The system may be further configured to automatically generate bill of material/schedule for the plurality of loads and equipment based on load and equipment characteristics and attributes, and transmit the generated bill of material/schedule to the user device and/or one or more servers associated with electrical equipment suppliers or vendors.

In additional aspects, the system may create/generate a data structure linking the load characteristics and attributes for the plurality of loads, and the equipment characteristics and attributes for the plurality of equipment. The data structure may be generated such that if the user changes any characteristic or attribute, corresponding linked characteristics and attributes may automatically change.

In further aspects, the system may automatically generate conduit system models based on user inputs associated with cables (e.g., cable characteristics and/or attributes), loads, cable trays, and/or the like, and the information associated with the electrical standard code. The system may generate the conduit system models so that the plurality of cables required to be installed in the building may be safely housed in one or more conduit segments, according to the electrical standard code.

In some aspects, the system may generate the conduit system models such that cables with same start locations and/or end locations may be housed in the same conduit systems. Further, cables with same cable types may be housed in the same conduit system. In some aspects, a conduit system model may include characteristics and/or attributes associated with one or more conduit segments that may be part of the conduit system that may house one or more cables. The system may automatically determine the conduit segment characteristics and/or attributes by correlating the user inputs with the information associated with the electrical standard code. The conduit system model may also include node characteristics/attributes associated with one or more nodes that may connect the conduit segments.

In further aspects, the conduit system model may include a schematic diagram or a riser diagram showing connections between different conduit segments, cable start and end locations, and one or more nodes. The system may be configured to display the generated conduit system model on a system user interface rendered on a user device, and the user may update the conduit system model (including the generated riser diagram) by clicking on the riser diagram and updating cable and/or load characteristics/attributes.

The system may also display prompts/messages on the system user interface, reminding or requesting the user to provide user inputs associated with loads, cables, conduits, etc., so that the generated conduit system model may be accurate and may not miss any important detail.

The present disclosure discloses system and method to facilitate the user in building the electrical installation model. Since the system builds the electrical installation model according to the electrical standard code/NEC, the electrical installation in the building may be secure and may adhere to safety standards. Further, the system automatically generates bill of material/schedule for the loads and the equipment that may be installed in the building, thus enhancing user convenience.

These and other advantages of the present disclosure are provided in detail herein.

### Illustrative Embodiments

The disclosure will be described more fully hereinafter with reference to the accompanying drawings, in which example embodiments of the disclosure are shown, and not intended to be limiting.

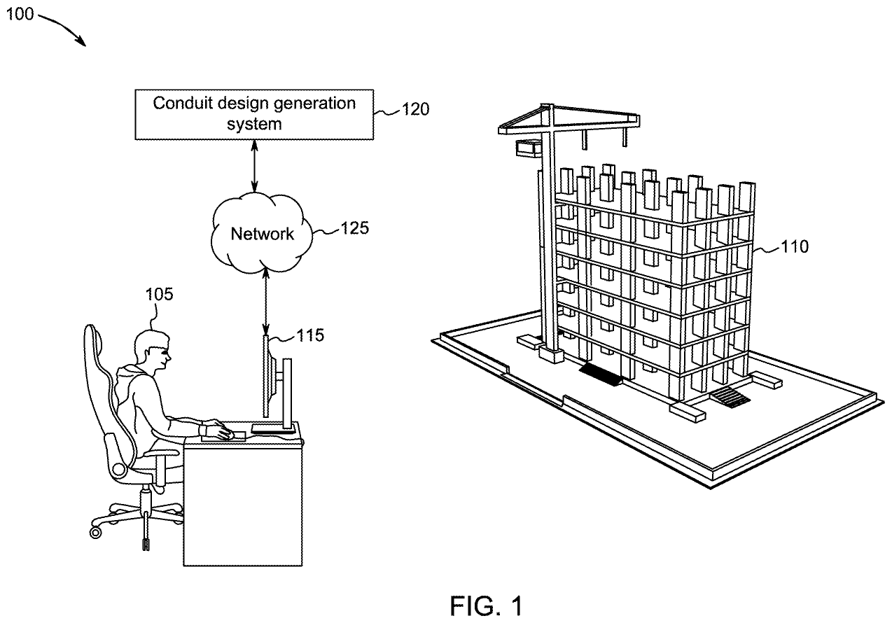

FIG. 1 depicts an example environment 100 in which techniques and structures for providing the systems and methods disclosed herein may be implemented. The environment 100 may include a user 105 who may be an electrical engineer or an electrical contractor tasked with planning installation of a plurality of loads and equipment in a building 110. The building 110 may be an under-construction or to-be-constructed residential, commercial or industrial building. The plurality of loads may include, but not limited to, lights or light fixtures, motors, receptacles, heaters, air conditioning systems, vendor panels, and/or any other similar electrical devices that may draw power from a power source to operate. The plurality of equipment may include, but not limited to, circuit breakers, fuse, cables, conduits, wall fixtures, raceways, cable trays, switchgear, and/or any other similar electrical equipment that may be required to be installed in the building 110 to safely transfer electrical energy from the power source to the loads and to ensure efficient load and power distribution operation. A person ordinarily skilled in the art may appreciate that raceways may include conduits, panels, boxes, gutters, troughs, wireways, or cable trays, all of which are components used to route, support, and physically protect the cables. Of all the raceway types, conduits are the most widely used. A conduit is a pipe or an elongated hollow structure specifically designed for the containment of cables. A conduit may be made from a variety of materials including, but not limited to, steel, aluminum, or PVC, and may be rigid or flexible. A wide variety of ‘fittings’ may be used for the installation of conduits throughout a wide range of environments in a building (e.g., the building 110).

In some aspects, the user 105 may use a user device 115 to access an electrical installation project planning system 120 or a conduit design generation system 120 (system 120) via one or more network(s) 125 to plan installation of the plurality of loads and equipment (e.g., cables, conduits, cable trays, etc.) in the building 110. In the present disclosure, the terms “electrical installation project planning system” and “conduit design generation system” are interchangeably used, and are collectively referred to as the system 120. The user device 115 may be, for example, a mobile phone, a laptop, a computer, a tablet, or any similar device with communication capabilities. The network 125 may be, for example, a communication infrastructure in which the connected devices discussed in various embodiments of this disclosure may communicate. The network 125 may be and/or include the Internet, a private network, public network or other configuration that operates using any one or more known communication protocols such as, for example, transmission control protocol/Internet protocol (TCP/IP), Bluetooth®, BLE®, Wi-Fi based on the Institute of Electrical and Electronics Engineers (IEEE) standard 802.11, UWB, and cellular technologies such as Time Division Multiple Access (TDMA), Code Division Multiple Access (CDMA), High Speed Packet Access (HSPDA), Long-Term Evolution (LTE), Global System for Mobile Communications (GSM), and Fifth Generation (5G), to name a few examples.

The system 120 may be hosted on a server, cloud, or a distributed computing system (not shown), and may be implemented in hardware, software (e.g., firmware), or a combination thereof. In some aspects, the system 120 may be configured to facilitate the user 105 in building or generating an electrical installation model or a conduit system design/model that may assist the user 105 in planning and executing installation of the plurality of loads and equipment in the building 110. The electrical installation model may include details of the plurality of loads and equipment using which the user 105 may conveniently generate bill of material or schedule that the user 105 may share with suppliers for quotes or bids. Further, the electrical installation model may include details of the plurality of equipment using which the user 105 may identify count, size and specification of each equipment that the user 105 may install in the building 110, while adhering to electrical installation safety standards (e.g., adhering to National Electrical Code (NEC)).

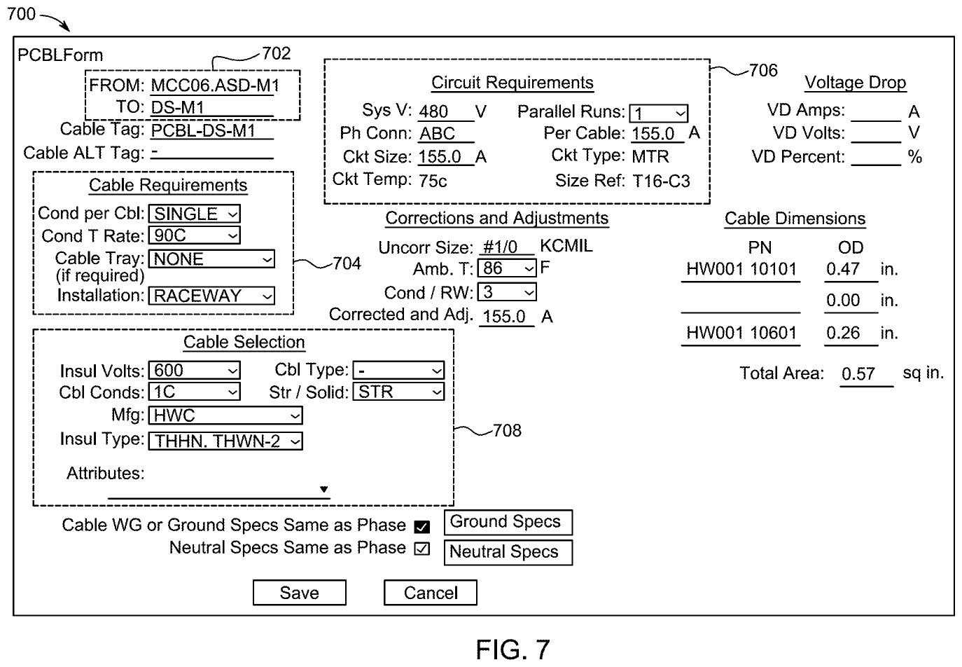

In further aspects, the conduit system design may include details associated with one or more conduit systems that may be installed in the building 110. For example, the conduit system design may include information of a plurality of conduit system models associated with a plurality of conduit systems that may be installed in the building 110 to house hundreds or thousands of cables that may be used in the building 110. In some aspects, the conduit system models may include characteristics of conduit segments, nodes, etc. that may be part of the conduit systems to be installed in the building 110, and the schematic diagrams showing the connections between the conduit segments, nodes, etc. In some aspects, the system 120 may be configured to automatically generate the schematic diagrams or “riser diagrams” or circuit diagrams associated with the conduit systems. In the present disclosure, the terms “schematic diagrams” and “riser diagrams” are interchangeably used (which may be same as circuit diagrams), and are used to denote the conduit schematic diagrams showing the connections between the conduit segments, nodes, etc., which are part of the conduit system models. Details associated with the conduit system models are described later in the description below in conjunction with FIGS. 7-14.

In an exemplary aspect, the user 105 may provide details (e.g., load characteristics and load attributes) of the plurality of loads to the system 120, via the user device 115 and the network 125. For example, the user device 115 may transmit load characteristics such as count and size (e.g., dimensions, ampacity, etc.) of each load to the system 120. Further, the user device 115 may transmit load attributes such as a distance (in X, Y and Z-axis) of each load from a power source, information associated with required physical location of each load in the building 110, information associated with load type (e.g., wall mounted, surface mounted, etc.) of each load, manufacturer part numbers of one or more loads, frequency of power input into a motor (if the load is a motor), and/or the like, to the system 120.

In some aspects, the user 105 may have access to and/or may refer to wiring schematics/diagrams associated with the plurality of loads (and equipment) to be installed in the building 110, when the user 105 transmits the load characteristics and load attributes to the system 120 via the user device 115.

In addition to providing the load characteristics and the load attributes to the system 120, the user 105 may provide equipment attributes associated with one or more equipment that may be installed in the building 110. Examples of equipment attributes include, but are not limited to, a required equipment physical location in the building 110, information associated with whether the equipment is to be mounted on a wall or to be disposed inside the wall in the building 110, equipment manufacturer part number, information associated with whether single cables or multi-conductor cables are to be included in one assembly (if the equipment are cables), information associated with whether a cable tray or a conduit need to carry the single cable or multiple cables (if the equipment is a cable tray or a conduit), and/or the like. In an exemplary aspect, the equipment attributes may include “cable attributes” including a cable start location (or a cable start point in the building 110) and a cable end location (or a cable end point in the building 110) associated with a plurality of cables to be installed in the building 110, information associated with cable type for each cable, and/or the like. As an example, the cable start location may be associated with a location of a load control unit/center (e.g., a motor control center), a cable tray, and/or the like, and the cable end location may be associated with a load. In some aspects, along with providing the cable attributes, the user 105 may provide one or more raceway or conduit attributes as well. In other aspects, some or all of the conduit attributes may be automatically estimated by the system 120, as described below in conjunction with FIGS. 7 to 14.

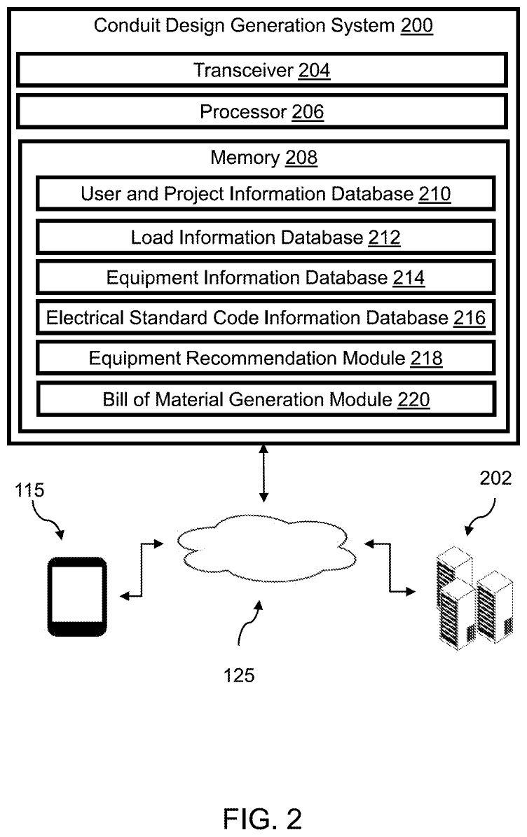

Responsive to obtaining the load characteristics, the load attributes and the equipment attributes, the system 120 may correlate the obtained information with information associated with an electrical standard code. Specifically, the system 120 may correlate the obtained information with information associated with an electrical standard code to identify specific portions or sections of the electrical standard code that may be applicable to each load and each equipment. For example, if the load is a motor, and the equipment are multi-conductor cables and conduits that may be used to supply power to the motor from a power source, the system 120 may identify those specific portions of the electrical standard code that may be applicable to the motor size and attributes (as included in the load characteristics and the load attributes) and the attributes of multi-conductor cables and conduits provided by the user 105. In this case, the system 120 may store the information associated with the electrical standard code in a system memory (shown as memory 208 in FIG. 2) or may access the information associated with the electrical standard code via an external server (shown as server 202 in FIG. 2). In an exemplary aspect, the electrical standard code may be the National Electrical Code (NEC) or NFPA 70, or any other similar electrical installation safety code. Information included in the NEC or NFPA 70 is incorporated by reference in the present disclosure. A person ordinarily skilled in the art may appreciate that since the NEC or NFPA 70 includes huge amounts of data, manually identifying specific portions or sections of the NEC or NFPA 70 that may be applicable to each load and each equipment may be time consuming and cumbersome. The system 120 automatically correlates the obtained load and equipment characteristic/attribute information with the huge amounts of data associated with the NEC or NFPA 70 to efficiently identify the specific NEC portions/sections described above. In this manner, the system 120 makes the process of building/generating an electrical installation model or a conduit design model more efficient, while adhering to the security guidelines included in the NEC/NFPA 70.

Responsive to identifying specific portions of the electrical standard code that may be applicable to each load and each equipment, the system 120 may calculate equipment characteristics for each equipment based on the load characteristics, the load attributes, the equipment attributes and the specific portions of the electrical standard code. Specifically, the system 120 may calculate the equipment characteristics based on the correlation described above. The equipment characteristics may include count and size/specification (e.g., dimensions, ampacity, etc.) of each equipment that may be required to be installed in the building 110. In additional aspects, the system 120 may estimate/calculate conduit characteristics and attributes based on the cable attributes provided by the user 105, the load characteristics and attributes connecting the cables, and the correlation described above (i.e., based on the identified specific portions of the electrical standard code). Since the system 120 calculates the equipment characteristics (and/or the conduit characteristics and attributes) based on the information included in the electrical standard code (e.g., the NEC), the equipment/conduit sizes calculated by the system 120 adhere to the electrical safety standards, and hence building owner and/or building occupant safety is ensured. For example, the system 120 may calculate dimensions/size of a conduit carrying multi-connector cables differently from a conduit that may carry a single conductor cable, according to the information included in the electrical standard code/NEC. The system 120 may further estimate an optimal conduit type based on the types of cables expected to be housed in the conduit. A person ordinarily skilled in the art may appreciate that the types of cables may in turn be based on the characteristics and attributes of the loads connected to the cables.

Responsive to calculating equipment characteristics for each equipment, the system 120 may transmit the equipment characteristics to the user device 115. In this manner, the user 105 may be able to obtain (e.g., view on a user device display or a system user interface rendered on the user device display) the equipment characteristics (and/or the conduit characteristics and attributes), and hence build the electrical installation model that includes characteristics and attributes of the plurality of loads and equipment that may be installed in the building 110, according to the electrical standard code/NEC.

In additional aspects, the system 120 may be configured to automatically generate riser diagrams showing connections between the conduit segments, nodes, loads, etc., based on the load characteristics and attributes provided by the user, and the conduit characteristics and attributes calculated/estimated by the system 120. The system 120 may further cause the system user interface rendered on the user device 115 to display the generated riser diagram(s), so that the user 105 may conveniently understand the generated conduit system model/design. The user 105 may also transmit, via the user device 115, the generated conduit system model/design including the riser diagrams and the conduit characteristics and attributes to third-party vendors, contractors for opinion and/or to obtain quotes/bids for the conduit segments, nodes, etc.

In some aspects, the riser diagrams generated by the system 120 may be dynamic in nature, and may automatically get updated when the user 105 updates any of the characteristics and/or attributes associated with the cables, loads, etc. In an exemplary aspect, the user 105 may update the characteristics and/or attributes associated with the cables, loads, etc. associated with a conduit system model by simply clicking on the riser diagram displayed on the system user interface, and updating the characteristics and/or attributes. In this manner, the system 120 generates a “connected” and dynamic riser diagram, which may enable the user to easily update the conduit system model.

In further aspects, the system 120 may automatically generate bill of material/schedule for each load based on load characteristics and attributes, and for each equipment (including raceways/conduits) based on equipment characteristics and attributes. A person ordinarily skilled in the art may appreciate that a bill of material or schedule includes details of the loads/equipment to be procured, and may be a detailed document listing specifications of each load and/or equipment component to be procured. Preparing such a detailed document manually may be a time consuming process, and may cause inconvenience to the contractors preparing the document(s). Further, manually preparing such a detailed document is an error-prone process, and may lead to incorrect entries and/or missing details. The system 120 automatically generates the bill of material/schedule based on the load and equipment (e.g., conduits') characteristics and attributes, thus significantly enhancing contractor's convenience and eliminating probability of any manual error while preparing such detailed documents.

The system 120 may further transmit the generated bill of material/schedule to the user device 115 to be rendered on the system user interface. The user 105 may send, via the user device 115, the bill of material/schedule to a plurality of suppliers/vendors to obtain quotes or bids to supply the plurality of loads and equipment. In other aspects, the system 120 may automatically transmit the generated bill of material/schedule to one or more servers or communication devices associated with the plurality of suppliers/vendors, who may provide the quotes or bids to the user device 115 and/or the system 120, responsive to receiving the bill of material/schedule.

In additional aspects, the system 120 may create a data structure linking the load characteristics and attributes, and the equipment characteristics and attributes. The data structure may be created such that if the user 105 makes a change in any one (or more) of the load characteristics, the load attributes, the equipment characteristics and/or the equipment attributes, corresponding remaining characteristics/attributes of loads and/or equipment may also change or get updated. For example, if the user 105 changes a motor size in the electrical installation model on the system 120, the system 120 may automatically change or update characteristics of one or more equipment that may be linked with the motor. In this case, responsive to receiving an update on a load characteristic/attribute or equipment characteristic/attribute, the system 120 may additionally update the bill of material/schedule, so that the user 105 and/or the plurality of suppliers/vendors may have access to (or receive from the system 120) the updated bill of material/schedule. Further, as described below, since the system 120 creates the data structure as described above, if the user 105 changes any characteristic or attribute associated with a cable or a load associated with a conduit system model, the conduit system model may automatically get updated. The conduit system model may include the schematic diagram or the riser diagram described above. Therefore, when the conduit system model gets updated based on the user inputs, the riser diagram also automatically gets updated. In this manner, the system 120 provides a “dynamic” conduit design generation feature to the user 105.

In some aspects, when the user 105 makes a change in any one (or more) of the load characteristics, the load attributes, the equipment characteristics and/or the equipment attributes (e.g., cable characteristics or attributes), the system 120 may charge or update the corresponding remaining characteristics/attributes of loads and/or equipment such that the updated characteristics/attributes comply with the electrical standard code or the NEC. Stated another way, in this case, when the user 105 makes a change in the data structure, the system 120 correlates the changed entry with the corresponding applicable section/portion of the electrical standard code, and then updates/changes the remaining characteristics/attributes based on the correlation. In this manner, the updated data structure also complies with the electrical standard code or the NEC. The system 120 is also configured to display the updated data structure on the system user interface rendered on the user device 115.

These and other system functions/operations are described in detail in conjunction with FIG. 2.

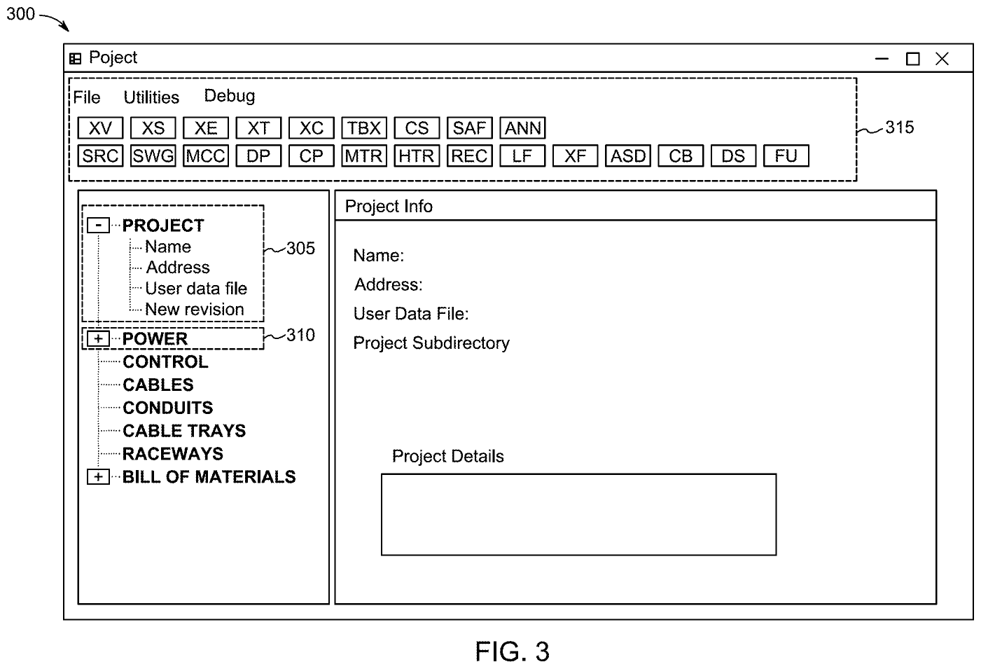

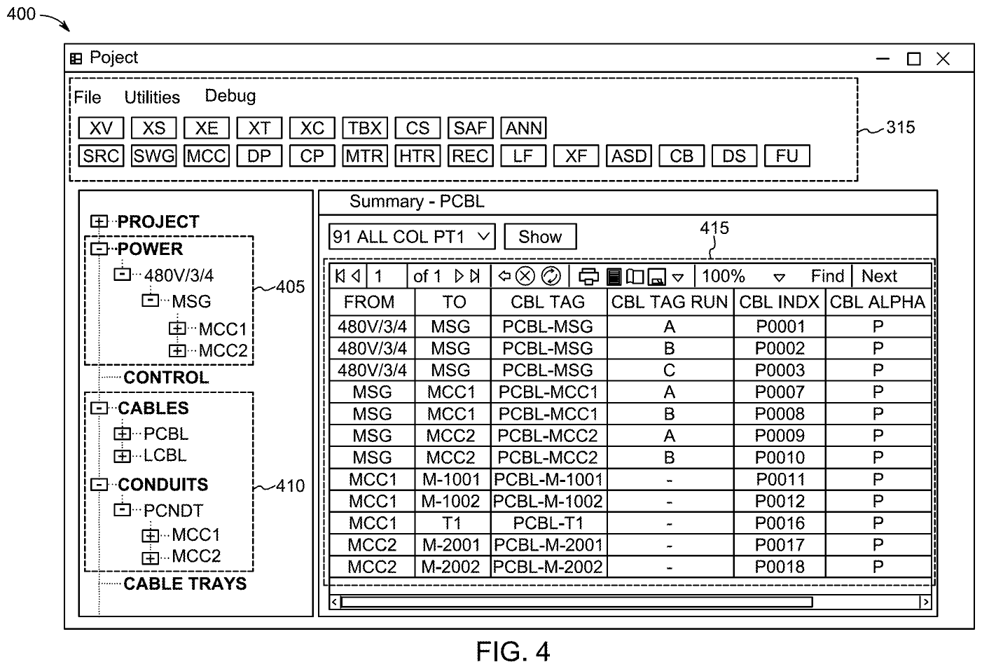

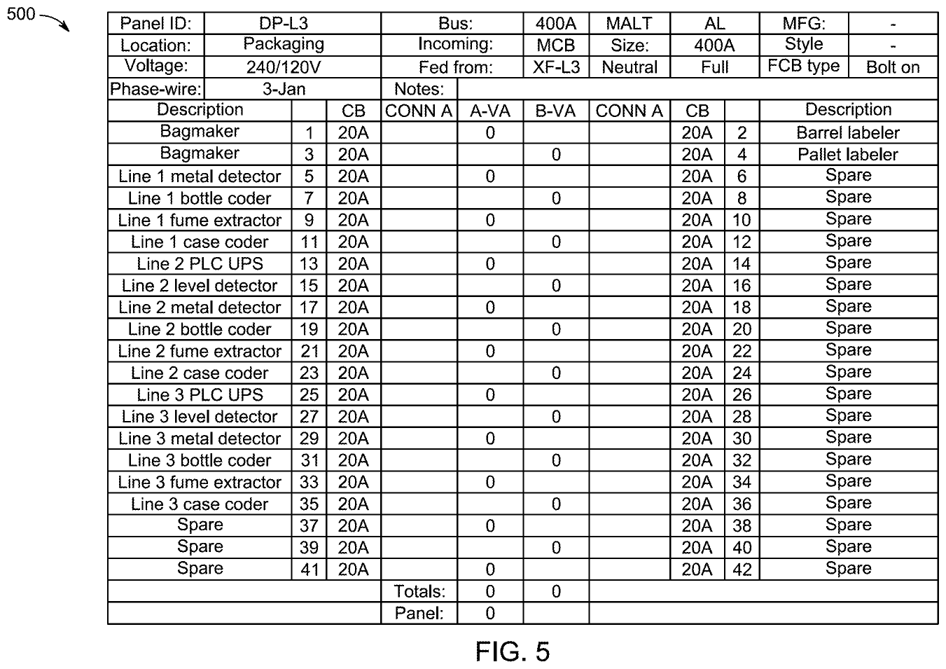

FIG. 2 depicts a block diagram of an example electrical installation project planning system 200 or conduit design generation system 200 (system 200) in accordance with the present disclosure. The system 200 may be same as the system 120 described in conjunction with FIG. 1. While describing FIG. 2, references may be made to FIGS. 3 and 4 that depict a first snapshot and a second snapshot respectively of a user interface of the system 200 that may be rendered on a display screen (e.g., user device 115 display screen). While describing FIG. 2, references may also be made to FIG. 5 that depicts an example schedule of equipment that may be installed in the building 110. Furthermore, while describing FIG. 2, references will be made to FIGS. 7-13 that are associated with generation of one or more conduit system models for conduit systems that may be installed in the building 110 to house one or more cables.

The system 200 may communicatively couple with the user device 115 and one or more server(s) 202 via the network 125. The server 202 may store the electrical standard code, e.g., the NEC, described above in conjunction with FIG. 1. Further, in some aspects, the server 202 may store information/details associated with a plurality of loads and/or equipment, e.g., manufacturer part numbers for the plurality of loads and/or equipment, information associated with ampacity, size, specification, etc. associated with each load and/or equipment, and/or the like. The server 202 may transmit the stored information/details associated with the plurality of loads and/or equipment to the system 200 at a predefined frequency, or when any information or detail may be updated on the server 202, or when the server 202 receives an information request from the system 200.

Although FIG. 2 depicts the system 200 being communicatively coupled with one user device, the system 200 may be coupled with a plurality of user devices simultaneously via the network 125, without departing from the present disclosure scope.

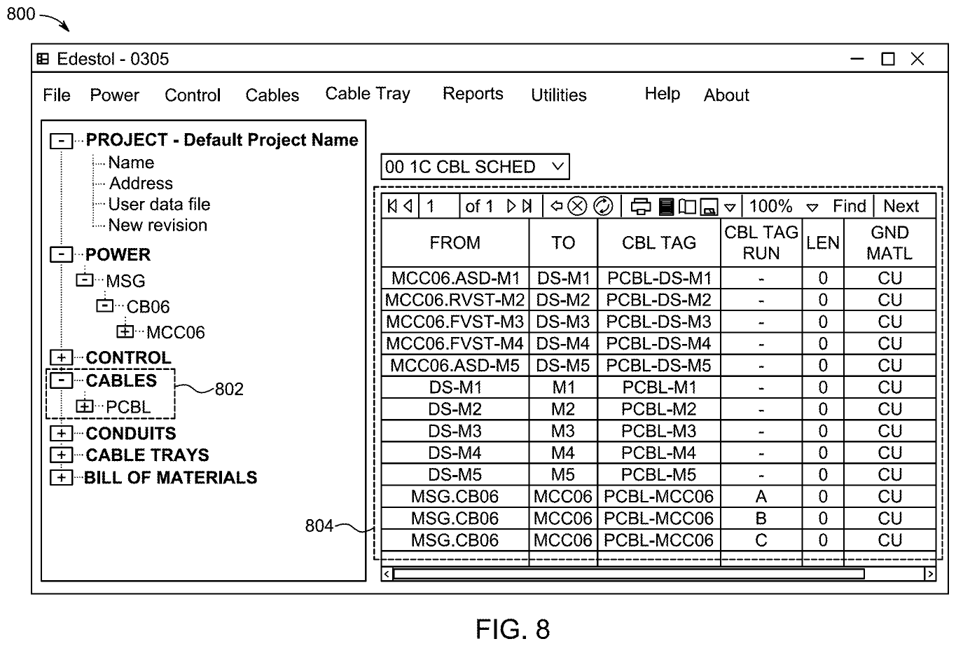

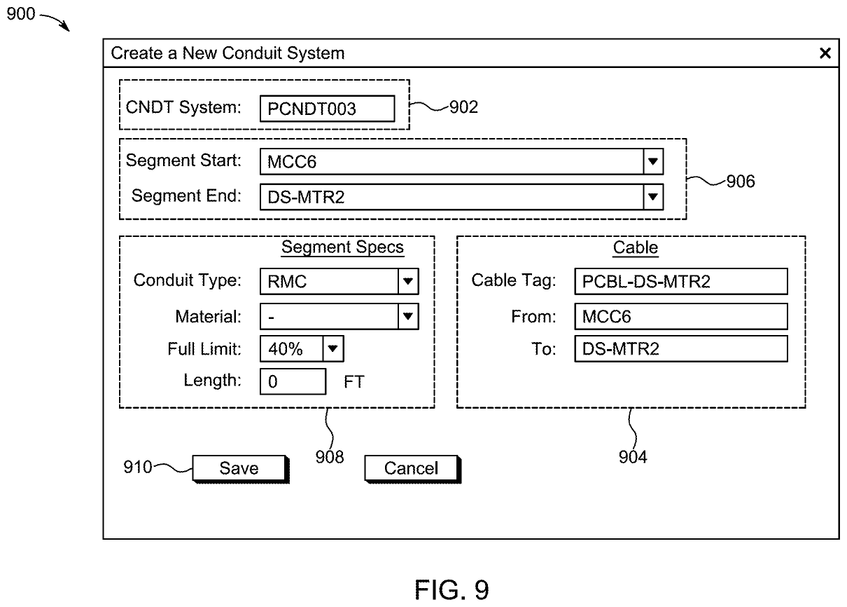

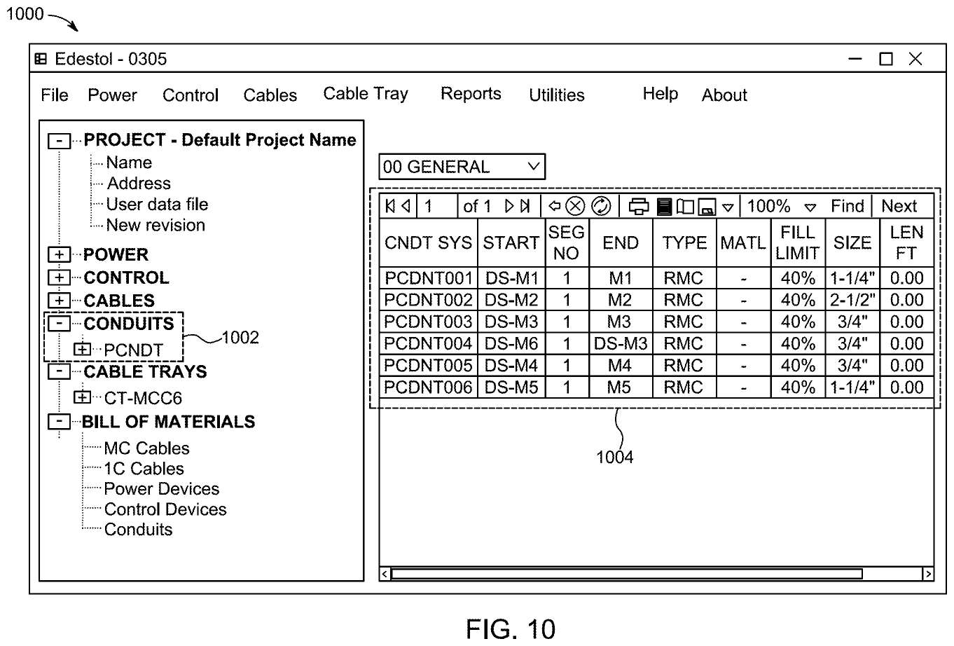

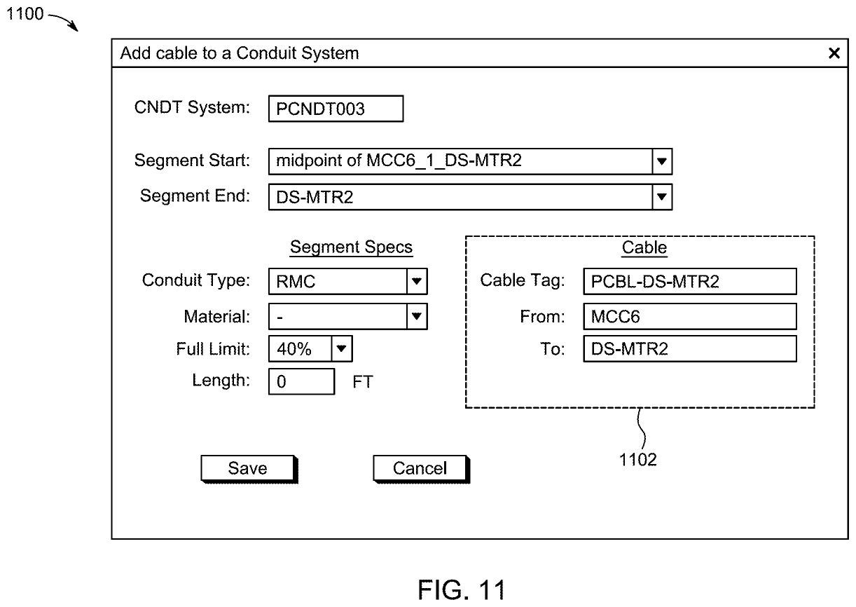

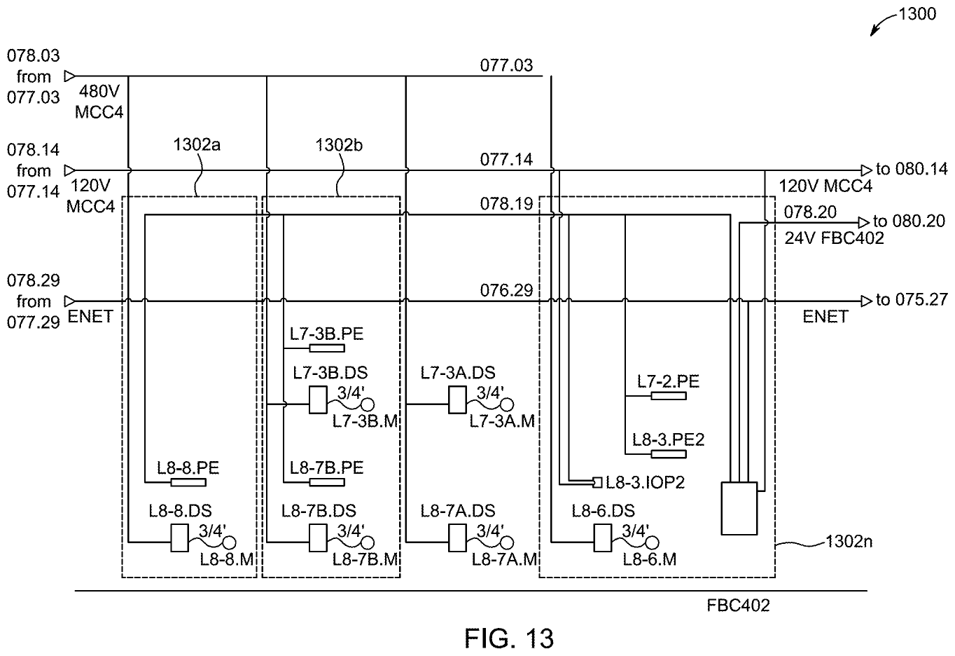

The system 200 may include a plurality of units including, but not limited to, a transceiver 204, a processor 206, and a memory 208. The transceiver 204 may be configured to receive/transmit data, notifications, information, from/to one or more external communication devices via the network 125. For example, the transceiver 204 may receive/transmit data, notifications, information, etc. from/to the user device 115 and the server 202 that may be coupled with the system 200 via the network 125. In some aspects, the transceiver 204 may be further configured to receive user inputs from the user 105 via a system user interface rendered on the user device 115. Examples of the system user interface are shown in FIG. 3 (as snapshot 300), FIG. 4 (as snapshot 400), FIG. 7 (as cable input form 700), FIG. 8 (as cable summary report 800), FIG. 9 (as conduit creation form 900), FIG. 10 (as snapshot 1000), FIG. 11 (as conduit insertion form 1100), and FIG. 13 (as riser diagram 1300). These snapshots and forms are described later in the description below. Further, examples of the user inputs are described later in the description below.

The memory 208 may store programs in code and/or store data for performing various system operations in accordance with the present disclosure. Specifically, the processor 206 may be configured and/or programmed to execute computer-executable instructions stored in the memory 208 for performing various system functions in accordance with the disclosure. Consequently, the memory 208 may be used for storing code and/or data code and/or data for performing operations in accordance with the present disclosure.

In one or more aspects, the processor 206 may be disposed in communication with one or more memory devices (e.g., the memory 208 and/or one or more external databases (not shown in FIG. 2)). The memory 208 can include any one or a combination of volatile memory elements (e.g., dynamic random-access memory (DRAM), synchronous dynamic random access memory (SDRAM), etc.) and can include any one or more nonvolatile memory elements (e.g., erasable programmable read-only memory (EPROM), flash memory, electronically erasable programmable read-only memory (EEPROM), programmable read-only memory (PROM), etc.).

The memory 208 may be one example of a non-transitory computer-readable medium and may be used to store programs in code and/or to store data for performing various operations in accordance with the disclosure. The instructions in the memory 208 can include one or more separate programs, each of which can include an ordered listing of computer-executable instructions for implementing logical functions.

In further aspects, the memory 208 may include a plurality of databases and modules including, but not limited to, a user and project information database 210, a load information database 212, an equipment information database 214, an electrical standard code information database 216, an equipment recommendation module 218, and a bill of material generation module 220. The equipment recommendation module 218 and the bill of material generation module, as described herein, may be stored in the form of computer-executable instructions, and the processor 206 may be configured and/or programmed to execute the stored computer-executable instructions for performing system functions in accordance with the present disclosure. The functions of the plurality of databases are described in the description below.

In operation, the processor 206 may first render a system user interface on the user device 115. An example system user interface rendered on the user device 115 is depicted in FIG. 3 as snapshot 300. Responsive to the processor 206 rendering the system user interface on the user device 115, the user 105 may use the system user interface to first create an account or a “project instance” or a new electrical installation project instance on the system 200 when the user 105 desires to build/generate an electrical installation model or a conduit system model on the system 200 to facilitate the user 105 in installing a plurality of loads and equipment in the building 110. To create the project instance, the user 105 may transmit, via the user device 115 (e.g., type or input on the system user interface rendered on the user device 115), information associated with the user 105 and an electrical installation project (that the user 105 may be tasked to implement) to the transceiver 204. The information associated with the user 105 may include, but is not limited to, user name, user contact details, user location, and/or the like. The information associated with the electrical installation project may include, but is not limited to, project name (e.g., “Electrical Installation Project”), project address (e.g., building address), data files associated with the project (e.g., wiring diagrams/schematics, etc.), and/or the like.

As described above, in some aspects, the user 105 may input the information associated with the user 105 and the electrical installation project, via the user device 115, on a system 200 user interface that may be rendered on a user device 115 display screen. An example first snapshot 300 of the system user interface is shown in FIG. 3. As shown in the snapshot 300, the user 105 may click on one or more links/tabs depicted in view 305 to input the information associated with the electrical installation project (and the user 105). Responsive to the user 105 inputting the information, the transceiver 204 may receive the information and send the information to the user and project information database 210 for storage purpose.

The user 105 may commence to build/generate the electrical installation model or conduit system model when the user device 115 transmits the information associated with the user 105 and the electrical installation project to the transceiver 204. Specifically, to build the electrical installation model, the user 105 may transmit, via the user device 115, selection or addition of one or more loads to the system 200. For example, the user 105 may click on a link/tab 310 on the system user interface to add one or more loads or power components that the user 105 may desire to install in the building 110. In some aspects, the user 105 may select the loads to be added to the electrical installation model by clicking on (or “dragging”) one or more load icons depicted as icons/identifiers 315 in the snapshot 300. In some aspects, the icons 315 may be known icons associated with a plurality of loads and equipment that may be installed in a building (e.g., the building 110). In other aspects, the user 105 may add the loads to the system 200 by typing names of loads to be added to the electrical installation model. An example second snapshot 400 of the system user interface is shown in FIG. 4, which depicts a plurality of loads added by the user 105 in the electrical installation model as view 405.

Responsive to the user 105 adding the loads, the transceiver 204 may receive corresponding load names or the identifiers from the user device 115 selected by the user 105, and may send the load names/identifiers to the load information database 212 for storage purpose. The user 105 may further transmit, via the user device 115, load characteristics and load attributes associated with each load to the transceiver 204, as described above in conjunction with FIG. 1. The transceiver 204 may receive the load characteristics and the load attributes from the user device 115, and may send the load characteristics and attributes to the load information database 212 for storage purpose.

In addition to selecting the loads and transmitting the load characteristics and attributes, the user 105 may select or add one or more equipment to the electrical installation model via the user device 115. The user 105 may select/add the equipment in a similar manner as selecting/adding the loads. The equipment may be cables, conduits, cable trays, fuse, relays, and/or the like. The snapshot 400 depicts one or more equipment added by the user 105 in the electrical installation model as view 410. As shown in the view 410, the user 105 may add one or more cables, conduits, etc. as equipment in the electrical installation model. In some aspects, the user 105 may add cables in the electrical installation model, and the estimation/calculation/recommendation of the conduits to be added may be automatically performed/provided by the system 200. In other aspects, the user 105 may add both cables and conduits in the electrical installation model, as shown in the snapshot 400. Responsive to the user 105 adding the equipment, the transceiver 204 may receive corresponding equipment names or identifiers from the user device 115, and send the equipment names to the equipment information database 214 for storage purpose. The user 105 may additionally transmit, via the user device 115, equipment attributes as described above in conjunction with FIG. 1. For example, the user 105 may provide/add, via the system user interface rendered on the user device 115, the cable attributes associated with a plurality of cables that may be required to be installed in the building 110. The transceiver 204 may receive the equipment attributes from the user device 115, and may send the equipment attributes to the equipment information database 214 for storage purpose.

The processor 206 may obtain the load characteristics, the load attributes, and the equipment attributes from respective databases or directly from the transceiver 204. Responsive to obtaining the characteristics and the attributes, the processor 206 may obtain information associated with the electrical standard code or NEC from the electrical standard code information database 216 (that may be pre-stored in the information associated with NEC) or the server 202 via the transceiver 204 and the network 125. The processor 206 may then correlate the load characteristics, the load attributes, and the equipment attributes with the information associated with the NEC. Specifically, the processor 206 may identify one or more sections or portions of the NEC that may apply (or be applicable) to each load and equipment installation in the building 110 by correlating the information described above. For example, if the user 105 desires to install 380/415 Volt, 50 Hz electric motor in the building 110 and use multi-conductor cables that may be disposed inside a wall to supply power to the motor, the processor 206 may identify one or more sections of the NEC that may apply to such a configuration or arrangement of electric motor and cables by performing the correlation described above.

Responsive to performing the correlation, the processor 206 may use the instructions stored in the equipment recommendation module 218 to calculate equipment characteristics based on the correlation. Specifically, the processor 206 may calculate equipment characteristics based on the load characteristics and attributes, the equipment attributes and the applicable NEC sections. Continuing with the example described above, the processor 206 may calculate dimensions/size (e.g., length, thickness, etc.) and specification (e.g., ampacity) of the multi-conductor cables that may be installed between the motor and the power source that may supply power to the motor, based on the motor characteristics and attributes, the cable attributes and the applicable NEC standard section(s). The processor 206 may further calculate characteristics of cable trays, circuit breakers, fuse, conduits, etc. that may be required to be installed in the electrical circuitry between the power source and the motor, based on the motor characteristics and attributes, the applicable NEC standard section(s) and equipment attributes.

Examples of equipment characteristics that the processor 206 may calculate include, but is not limited to, ampacity of feeders, ampacity of branch circuit, sizes of overcurrent protective devices, motor control equipment, conduits, cables, raceways, cable tray, control and signal devices, and/or the like. Details of estimating conduit characteristics or generating “conduit system models” are described later in the description below in conjunction with FIGS. 7-14. In some aspects, generating a conduit system model may mean automatically determining appropriate conduit segment characteristics and/or attributes associated with one or more conduit segments that may be part of a conduit system, node characteristics associated with one or more nodes that may be part of the conduit system, and/or the like.

Responsive to calculating the equipment characteristics, the processor 206 may transmit, via the transceiver 204, the equipment characteristics to the user device 115 so that the user 105 may view the equipment characteristics (e.g., count, size, specification of each equipment), and may plan equipment procurement. An example view of the equipment characteristics (and attributes) is shown as view 415 in the snapshot 400.

In this manner, the processor 206 may facilitate the user 105 in building the electrical installation model that includes characteristics (e.g., count, size, specification, etc.) and attributes of all loads and equipment that may be installed in the building 110. Since the equipment characteristics calculated by the processor 206 are based on NEC, the equipment that may be installed in the building 110 may be secure and may adhere to safety standards.

In addition to calculating the equipment characteristics, the processor 206 may generate a data structure linking the load characteristics and attributes for the plurality of loads, and the equipment characteristics and attributes for the plurality of equipment. The data structure may be generated such that if the user 105 changes any characteristic or attribute, corresponding linked characteristics and attributes automatically change (i.e., the data structure automatically changes). For example, if the user 105 changes a motor size, the data structure may automatically adjust cable size, conduit size, cable tray size, circuit breaker size, fuse size, motor starter size, safety disconnect switch size, motor control center size, adjustable speed drive size, etc. associated with the motor. Similarly, if the user 105 changes characteristics or attributes related to the cables, the conduit characteristics and/or attributes may automatically change based on the changes made to the cables. Further, as described above, if the user 105 changes characteristics or attributes related to the cables, loads, etc., the generated conduit system model (including the riser diagram) may get dynamically updated. In some aspects, the processor 206 may store the generated data structure in the memory 208, and/or cause the system user interface to display the generated data structure.

In further aspects, responsive to performing the correlation and calculating the equipment characteristics or in parallel to calculating the equipment characteristics, the processor 206 may determine one or more additional or intermediary equipment for which the user 105 may not have provided attributes or the user 105 may have missed adding such equipment in the electrical installation model. For example, the processor 206 may determine that the user 105 may not have selected and/or provided attributes for cable trays or raceways, based on the equipment attributes provided by the user 105 via the user device 115, and a list of plurality of equipment required to be installed in the building 110 according to the NEC (as determined via the correlation). Stated another way, the processor 206 may determine additional or intermediary equipment (that the user 105 may have missed adding to the electrical installation model) that may be required to be installed in the building 110 based on the load attributes and characteristics and the NEC. Responsive to determining the additional equipment, the processor 206 may transmit, via the transceiver 204, a recommendation notification to the user device 115. The recommendation notification may include names or identifiers of additional equipment. The user 105 may view the additional equipment names or identifiers on the user device 115, and may transmit attributes associated with the additional equipment to the system 200 via the user device 115. The processor 206 may further calculate additional equipment characteristics (e.g., count, size, specification, etc.) in a similar manner as described above.

Although the description above describes an aspect where the processor 206 identifies the additional equipment (e.g., conduits) that the user 105 may have missed adding to the electrical installation model/project or missed providing the attributes for, after the processor 206 calculates the equipment characteristics; however, the present disclosure is not limited to such an aspect. In alternative or additional aspects, the processor 206 may cause the system user interface to output or display preset prompts or messages, requesting the user 105 to add attributes (or characteristics) of equipment (e.g., conduits) that the user 105 may miss, while the user 105 may be adding attributes for other equipment (e.g., cables). Such prompts/messages assist the user 105 in ensuring that the user 105 provides attributes (or characteristics) associated with conduits when the user 105 may be adding attributes (or characteristics) of cables, so that the user 105 may not miss adding conduits to the electrical installation project/model. Examples of such prompts/messages are described below in conjunction with FIGS. 7-13.

In yet another aspect, responsive to calculating the equipment characteristics (and the additional equipment characteristics), the processor 206 may use instructions stored in the bill of material generation module 220 to automatically generate bill of material or schedule for each load and equipment based on the load characteristics and the equipment characteristics. An example snapshot 500 of a schedule is shown in FIG. 5.

Responsive to generating the bill of material or schedule for each load and equipment (e.g., cables, conduits, cable trays, etc.), the processor 206 may transmit, via the transceiver 204, the bill of material/schedule to the user device 115. The user 105 may view the bill of material/schedule on the system user interface, and may transmit the bill of material/schedule to one or more suppliers or vendors for quotes or bids via the user device 115. In this manner, the processor 206 eliminates the need for the user 105 to manually count each equipment that may be required to be installed in the building 110 and prepare the bill of material/schedule. In some aspects, the processor 206 may automatically transmit, via the transceiver 204, the bill of material/schedule to one or more servers (not shown) associated with the suppliers or vendors, so that the system 200 and/or the user device 115 may receive quotes or bids.

In further aspects, responsive to calculating the equipment characteristics, the processor 206 may automatically generate one-line diagram(s) of the electrical installations that may be installed in the building 110. The processor 206 may transmit, via the transceiver 204, the generated one-line diagram(s) to the user device 115, thus enhancing user convenience in planning electrical installations in the building 110.

In additional aspects, the system 200/processor 206 may be configured to generate electrical installation models including conduit system models, based on inputs provided by the user 105 (e.g., load and equipment characteristics and/or attributes described above). In this case, the processor 206 may first determine that the user 105 may have created a new electrical installation project instance on the system 200 via the system user interface rendered on the user device 115, when the processor 206 renders the system user interface on the user device 115.

Responsive to determining that the user 105 may have created a new electrical installation project instance on the system 200 (or responsive to rendering the system user interface on the user device 115), the processor 206 may cause the system user interface to display/output a message or a prompt requesting the user 105 to perform a predefined action on the system user interface. The message/prompt may be in the form of an input form (a cable input form 700 shown in FIG. 7) or a textual or audible message output by the user device 115, indicating to the user 105 that the user 105 may be required to add inputs associated with loads, cables, etc. that the user 105 desires to install in the building 110 or add to the new electrical installation project. Such messages or prompts (e.g., the cable input form 700) may assist in “reminding” the user 105 that the user 105 is required to add characteristics/attributes of different loads/equipment (e.g., cables in the example depicted in FIG. 7), and helps in making sure that no essential equipment is missed by the user 105 in adding to the electrical installation project/model. A person ordinarily skilled in the art may appreciate that an electrical installation project for a building (e.g., the building 110) may be incomplete if the user 105 misses to provide characteristics/attributes associated with essential equipment such as cables, conduits, cable trays, etc. The messages/prompts output by the processor 206 (via the system user interface) ensures that no essential equipment is missed and the electrical installation project/model is built efficiently and accurately (and eliminating need for any re-work on the electrical installation project/model by the user 105).

Responsive to hearing/viewing the prompt or the message, the user 105 may perform the predefined action on the system user interface. In one exemplary aspect, the predefined action may include the user 105 typing the user inputs associated with the loads, cables, etc. on the system user interface via a user device touchscreen or a keypad/keyboard associated with the user device 115. For example, when the message/prompt is shown as the cable input form 700, the user 105 may input/type the cable attributes or the user inputs associated with one or more cables in the cable input form 700. In the exemplary view of the cable input form 700 depicted in FIG. 7, the user 105 may input/type a cable start location/point and a cable end location/point associated with a cable in an input zone 702, and one or more additional cable attributes (if the user 105 desires to add in the cable input form 700) in zones 704, 706, 708, and/or the like. As described above, the system 200/processor 206 may be configured to automatically calculate/estimate the equipment characteristics (e.g., a cable length, specification, etc.) based on the user inputs associated with load characteristics and attributes, equipment attributes, and the information associated with the electrical standard code (e.g., the NEC).

In further aspects, as described above, the system user interface may include or display the plurality of preset icons/identifiers 315 that may be associated with a plurality of loads and equipment (e.g., cables) that may be installed in the building 110. As shown in FIGS. 3 and 4, the icons 315 may be located at a first predefined location on the system user interface, which may be at a system user interface top portion (although the present disclosure is not limited to such an aspect). In one exemplary aspect, the predefined action that the user 105 performs on the system user interface to add the user inputs associated with the load and equipment (e.g., cables) may include clicking or selecting one or more icons (e.g., icons associated with the cable(s) that the user 105 prefers to install in the building 110 or add to the electrical installation project), from the plurality of icons 315, on the system user interface. In a second exemplary aspect, the predefined action that the user 105 performs on the system user interface to add the user inputs associated with the load and equipment (e.g., cables) may include dragging one or more icons, from the plurality of icons 315, on the system user interface from the first predefined location to a second predefined location (e.g., to the “CABLES” tree-view show in the view 410 of FIG. 4). In this case, to add a specific cable (e.g., a cable of a specific cable type) to the electrical installation project, the user 105 may drag the icon associated with the specific cable from the first predefined location to the “CABLES” tree-view show in the view 410. Performing such an action may cause the processor 206 to add the selected cable to the electrical installation project. Responsive to adding the cable in this manner, the user 105 may add the cable attributes (e.g., cable start and end locations, and/or cable type) by clicking on the icon of the cable included in the “CABLES” tree-view, and/or via the cable input form 700 described above.

A person ordinarily skilled in the art may appreciate that there are a plurality (e.g., hundreds or thousands) of different types of loads and equipment that are required to be added to an electrical installation project/model to prepare a robust and accurate electrical installation plan that may be implemented for a building (e.g., the building 110). The user 105 may not always remember all the loads and equipment, and in some cases may not even know the different types of loads/equipment that are available, which the user 105 may add to the electrical installation project/model. Displaying the various available loads/equipment as “icons” (e.g., the icons 315) assists the user 105 in conveniently “knowing” the different types of available loads/equipment that the user 105 may use in the building 110. Further clicking or “dragging” such icons are much more easier for the user 105 building the electrical installation project/model than typing the names of the loads/equipment, and hence such icons 315 significantly enhance user's convenience of building the electrical installation project/model using the system 200.

Responsive to the user 105 performing the predefined action described above (i.e., the user 105 adding the user inputs associated with the loads, equipment/cables, etc.), the processor 206 may cause the system user interface to display/output one or more summary reports (e.g., a load summary report, a cable summary report, etc.). An example cable summary report 800 displayed on the system user interface is depicted in FIG. 8. As shown in FIG. 8, the cable summary report 800 may include identifiers 802 of a plurality of cables selected/added by the user 105. In some aspects, the identifiers 802 may be automatically created/generated by the processor 206 based on a cable start location/point, a cable end location/point, a cable type, and/or the like. In other aspects, the user 105 may also create/add the identifiers 802 to the electrical installation project/model. In additional aspects, the cable summary report 800 may include details 804 associated with the plurality of cables selected/added by the user 105. The details 804 may include the cable attributes (some or all of which may be added by the user 105) and the cable characteristics (e.g., cable length, dimensions, etc.) that the system 200/processor 206 may automatically calculate based on the load characteristics and attributes, cable attributes and the information associated with the electrical standard code (e.g., the NEC), as described above. Such a summary report may assist the user 105 in re-checking whether the user 105 has added all the information (e.g., cable attributes) correctly, and/or the user 105 may have missed adding any information or any particular cable may have been missed.

In further aspects, responsive to the user 105 performing the predefined action described above (i.e., the user 105 adding the user inputs associated with the loads, equipment/cables, etc.) or when the user 105 performs the predefined action on the system user interface, the transceiver 204 may receive the user inputs from the user 105 via the system user interface rendered on the user device 115. The transceiver 204 may transmit the received user inputs to the processor 206, and to the memory 208 for storage purpose. Since the transceiver 204 receives the user inputs from the user 105 via the system user interface, a person ordinarily skilled in the art may appreciate from the description above that the processor 206 obtains the user inputs from the transceiver 204 (or from the user 105) when or after the processor 206 renders the system user interface on the user device 115 or when the user 105 performs the predefined action on the system user interface.

In some aspects, the user inputs received by the transceiver 204 from the system user interface or obtained by the processor 206 may include a first start location and a first end location associated with a first cable to be installed in the building 110, information associated with a first cable type, first cable attributes, and/or the like. The first cable attributes may include information associated with required physical location of the first cable in the building 110, information associated with whether the cable is to be mounted on a wall or to be disposed inside the wall in the building 110, cable manufacturer part number(s), and/or the like. In an exemplary aspect, the first start location may be associated with a load control center, a cable tray, and/or the like, and the first end location may be associated with a first load to be installed in the building 110. Stated another way, in an exemplary aspect, the first cable may connect a load control center, a cable tray, and/or the like, with the first load (which may be, e.g., a motor, a lighting fixture, etc.). In some aspects, the user inputs may further include the first load characteristics and attributes. As described above, the first load characteristics may include a load size, a load count, etc., and the first load attributes may include information associated with physical location of the first load in the building 110, distance of the first load from one or more power sources, and/or the like.

Responsive to obtaining the user inputs described above, the processor 206 may output/display another prompt or message on the system user interface rendered on the user device 115, requesting the user 105 to create a “new conduit system” instance on the electrical installation project. As described above, such prompts/messages may assist in “reminding” the user 105 that along with adding cables (e.g., the first cable) to the electrical installation project/model, conduits are also required to be added to the project/model, as conduits are important to secure the cables and avoid any adverse situation in the building 110.

In the present disclosure, the term “conduit system” refers to one or more conduit segments that may house the cables (e.g., the first cable described above) to be installed in the building 110, and one or more nodes that may connect one or more conduit segments. Further, a conduit segment may be defined as a continuous length of conduit whose beginning/start and end may be an equipment, a cable tray, boxes, loads, or devices, and may also begin or end at another conduit segment (e.g., via a fitting). A node is a location in the conduit system where segments are joined, e.g., via one or more fittings.

In some aspects, the processor 206 may output the prompt/message described above requesting the user 105 to create a new conduit system instance on the electrical installation project by displaying a textual message on the system user interface or outputting an audible message via the user device 115. In other aspects, the processor 206 may cause the system user interface to display a conduit creation form 900, as shown in FIG. 9. Responsive to the processor 206 causing the system user interface to display the conduit creation form 900, the user 105 may add one or more details to the conduit creation form 900, and the processor 206 may also auto-populate one or more fields in the conduit creation form 900. For example, the user 105 may add a conduit system name in a field 902, or the processor 206 may auto-populate the conduit system name. The user 105 may further add the first cable start location/point and the first cable end location/point in a field 904 (or the processor 206 may auto-populate based on the user inputs provided in the cable input form 700). The processor 206 may then auto-populate a field 906 based on the first cable start location and the first cable end location. The field 906 may be associated with a start and end location of a first conduit segment that may house the first cable from the first cable start location to the first cable end location.

In further aspects, the processor 206 may calculate the conduit segment specs (which may be conduit segment characteristics) shown in a field 908 based on the first load characteristics, the first cable attributes, the first cable start and end locations, and the information associated the electrical standard code (e.g., the NEC), as described above. In other aspects, the user 105 may also add one or more specs in the field 908. The user 105 may view the details depicted in the conduit creation form 900, and then click on a save button 910 to create a new conduit system instance on the electrical installation project if the details are accurate and according to user's requirements.

Although the description above describes an aspect where the processor 206 may cause the system user interface to display the message/prompt in the form of the conduit creation form 900, the present disclosure is not limited to such an aspect. In additional or alternative aspects, when the processor 206 outputs the message/prompt in the form of a textual message or an audible message, the user 105 may “drag” one or more cables from the identifiers 802 into a conduit identifier 1002 associated with a plurality of conduit systems (instances of which may already be created on the electrical installation project) shown in a snapshot 1000 depicted in FIG. 10.

In some aspects, since the user 105 may have already provided the first cable details in the cable input form 700, an identifier associated with the first cable may already be created in the identifiers 802. In this case, to create a conduit system for the first cable, the user 105 may simply drag the identifier associated with the first cable to the conduit identifier 1002, and the processor 206 may automatically create the conduit system for the first cable. As described above, the dragging operation enhances user's convenience of operating the system 200. An example conduit summary report 1004, similar to the details 804 associated with the cable summary report 800, is depicted in FIG. 10. The conduit summary report 1004 may include details (e.g., characteristics and attributes) associated a plurality of conduit systems (or conduit system instances or models) already created on the electrical installation project/system 200.

Responsive to obtaining the user inputs from the user 105 (as described above) and the user 105 creating a new conduit system instance on the electrical installation project, the processor 206 may generate a first conduit system model configured to house the first cable based on the user inputs and the information associated with the electrical standard code. Specifically, the processor 206 may generate the first conduit system model based on the first cable start location, the first cable end location, the first cable attributes, the first cable type, the first load characteristics, and the information associated with the electrical standard code. More specifically, the processor 206 may correlate the first cable start location, the first cable end location, the first cable attributes, the first cable type, and the first load characteristics with the information associated with the electrical standard code to generate the first conduit system model that may be compliant with the electrical standard code (e.g., the NEC).

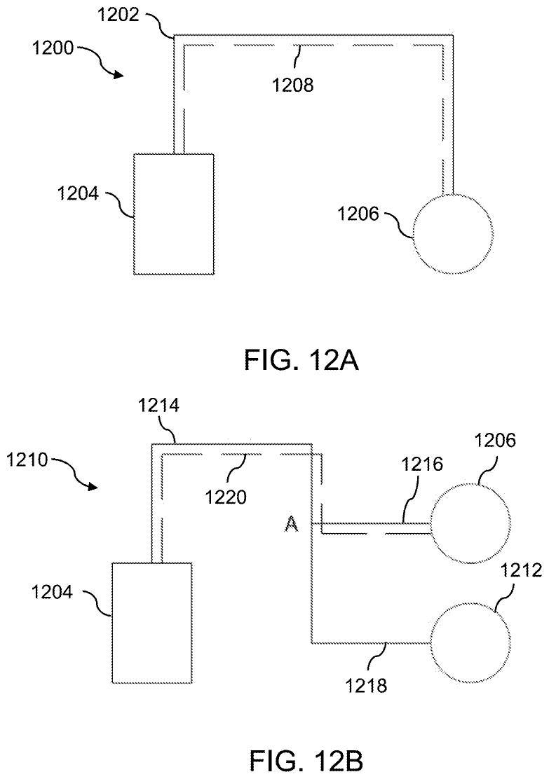

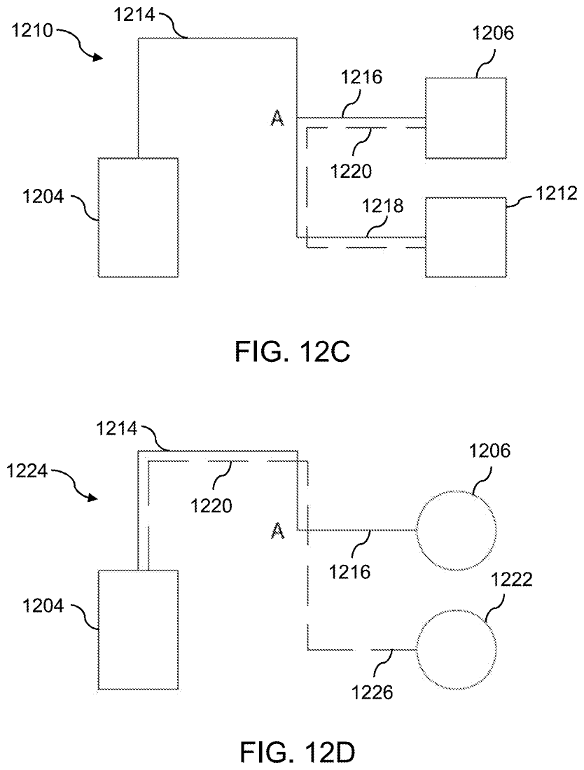

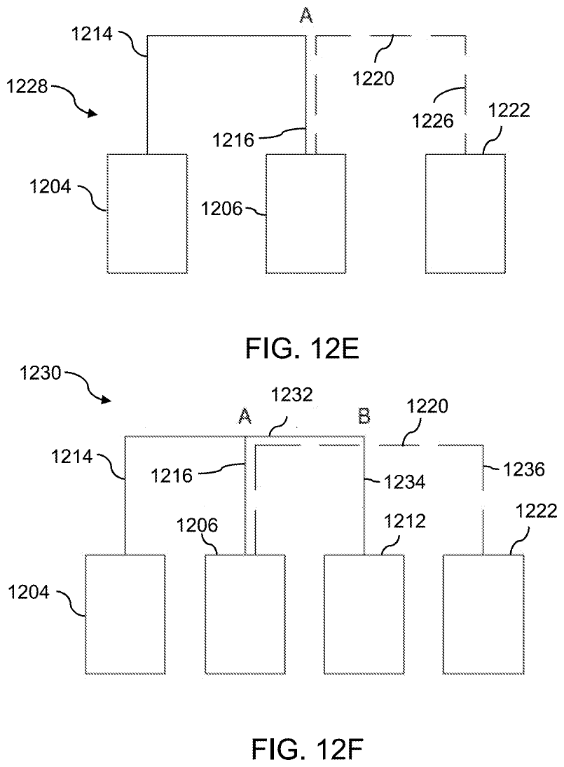

In some aspects, the first conduit system model generated by the processor 206 may include first segment characteristics associated with a first conduit segment configured to house the first cable from the first start location to the first end location, and a first schematic diagram of the first conduit segment connecting the first start location and the first end location. “Generating” a conduit system model (e.g., the first conduit system model) may mean determining the conduit segment characteristics (e.g., the first segment characteristics) and automatically generating/creating a schematic diagram associated with the conduit system. An example first schematic diagram 1200 (or a first riser diagram) associated with the first conduit system model is depicted in FIG. 12A. The first schematic diagram 1200 depicts a first conduit segment 1202 that may house the first cable. Further, a first cable start location (which may be same as a first segment start location) is depicted as a first start point 1204, and a first cable end location (which may be same as a first segment end location) is depicted as a first end point 1206.

In some aspects, the first segment characteristics associated with the first conduit segment 1202 may include information associated with one or more of an optimal first conduit segment material, a maximum permissible first conduit segment fill limit percentage, a first conduit segment length, first conduit segment dimensions, an optimal first conduit segment type, and/or the like.

Responsive to generating the first conduit system model, the processor 206 may cause the system user interface to display the first conduit system model. Specifically, the processor 206 may cause the system user interface to display the first schematic diagram 1200 and the first segment characteristics. By automatically generating the first schematic diagram 1200 and determining the first segment characteristics based on the NEC, the processor 206 facilitates the user 105 in quickly and accurately determining conduit type, length, etc. that the user 105 may be required to install in the building 110 to safely house the first cable. The user 105 may check the first conduit system model on the system user interface for accuracies, and may also share the model with other users/experts (e.g., via the user device 115) to gather second opinion and/or to vendors to obtain quote or bids. In some aspects, the user 105 may also update the first conduit system model by clicking on the first schematic diagram 1200, and updating characteristics/attributes associated with the first cable and/or the first load. In this case, responsive to the user 105 updating the characteristics/attributes, the first conduit system model (including the first schematic diagram 1200) may dynamically get updated and displayed on the system user interface.

A person ordinarily skilled in the art may appreciate in a building (e.g., the building 110), hundreds or thousands of cables are installed, and one conduit system may be used to house multiple cables. Therefore, responsive to generating the first conduit system model, the system 200/processor 206 may further enable the user 105 to “add” more cables to the first conduit system model, so that the same conduit system may house multiple cables.

To facilitate/enable the user 105 to conveniently add a second cable to the first conduit system model, the processor 206 may cause the system user interface to display another prompt or message, which may be, for example, in the form of a cable insertion form 1100, shown in FIG. 11. The cable insertion form 1100 may be similar to the conduit creation form 900, and the user 105 may add the second cable's start location and end location in a field 1102. Remaining fields in the form 1100 are similar to the fields in the form 900, and hence are not described again here for the sake of simplicity and conciseness.

In some aspects, in addition to or alternative to using the form 1100 to add the second cable to the first conduit system model, the user 105 may drag an identifier associated with the second cable from the identifiers 802 into the conduit identifier 1002, as described above.

In some aspects, the user inputs described above that the transceiver 204 receives (and the processor 206 obtains) from the user 105 via the system user interface rendered on the user device 115 may include a second start location and a second end location associated with the second cable to the installed in the building 110 that the user 105 desires to add to the first conduit system model. Similar to the first start location, the second start location may also be associated with a load control center (e.g., a motor control center) or a cable tray, and the second end location may be associated with a second load to be installed in the building 110. In some aspects, the user inputs may further include second load characteristics and attributes, information associated with a second cable type, and second cable attributes. The second load characteristics and attributes may be similar to the first load characteristics and attributes, and the second cable attributes may be similar to the first cable attributes.

In some aspects, responsive to generating the first conduit system model, the processor 206 may obtain the second start location, the second end location, the second cable attributes, the second cable type, and the second load characteristics and attributes (that are part of the user inputs obtained by the processor 206 from the transceiver 204). Responsive to obtaining the information described above, the processor 206 may determine/check whether the first start location is same as the second start location and/or the first end location is same as the second end location.

The processor 206 may generate a first error notification when the processor 206 determines that neither the first start location is same as the second start location, nor the first end location is same as the second end location. Stated another way, the processor 206 may generate the first error notification when the first and second cables do not share either their start locations or their end locations. In this case, the processor 206 may cause the system user interface to display the first error notification. The first error notification may indicate to the user 105 that the first cable cannot be housed in the same conduit system as the second cable, as the two cables do not have start or end locations common.

The processor 206 may further determine/check whether the first cable type is same as the second cable type based on the information associated with the first cable type and the second cable type (which may be part of the user inputs). The processor 206 may generate a second error notification and cause the system user interface to display the second error notification when the processor 206 determines that the first cable type is not same as the second cable type. The second error notification may indicate to the user 105 that since the first and second cables are of different types, the first and second cables cannot be housed in the same conduit system.

On the other hand, responsive to determining that at least one of the first start location is same as the second start location or the first end location is same as the second end location, and the first cable type is same as the second cable type, the processor 206 may modify the first conduit system model to generate a second conduit system model configured to house the first and second cables, based on the user inputs. Specifically, the processor 206 may generate the second conduit system model based on the first and second start locations, the first and second end locations, the first and second cable attributes, the first and second cable types, the first and second load characteristics and attributes, and the information associated with the electrical standard code. More specifically, the processor 206 may correlate the first and second start locations, the first and second end locations, the first and second cable attributes, the first and second cable types, and the first and second load characteristics and attributes with the information associated with the electrical standard code to generate the second conduit system model that adheres to the safety guidelines included in the NEC.

In an exemplary aspect, the second conduit system model may be same as the first conduit system model when the first start location may be same as the second start location and the first end location may be same as the second end location. Stated another way, if the second cable has start and end locations same as the start and end locations associated with the first cable, the first conduit system model may be used to house the second cable along with the first cable. Specifically, in this case, the first conduit segment 1202 may be configured to house the first and second cable simultaneously. An example second cable 1208 configured to be housed in the first conduit segment 1202 is depicted in FIG. 12A.

On the other hand, the second conduit system model may be different from the first conduit system model when the first start location may be different from the second start location or the first end location may be different from the second end location. An example second schematic diagram 1210 associated with the second conduit system model is depicted in FIG. 12B, where the first start location and the second start location may be same as the first start point 1204, however, the first end point 1206 may be different from a second end location/point 1212. In this case, the first end point 1206 may be a first load/motor, and the second end point 1212 may be a second load/motor that may be different from the first load/motor. In an exemplary aspect, in this case, the first start point 1204 may be a motor control center that may be connected to and configured to control the first and second motors.

In this case, the second conduit system model may include second segment characteristics associated with a second conduit segment 1214, node characteristics associated with a node “A”, third segment characteristics associated with a third conduit segment 1216, fourth segment characteristics associated with a fourth conduit segment 1218, and the second schematic diagram 1210 (or riser diagram associated with the second conduit system model) connecting the second conduit segment 1214, the third conduit segment 1216, the fourth conduit segment 1218 and the node “A”. Each of the second segment characteristics, the third segment characteristics and the fourth segment characteristics may include one or more of an optimal segment material, a maximum permissible segment fill limit percentage, a segment length, segment dimensions, an optimal segment type, and/or the like associated with the respective conduit segment. Further, the node characteristics may include an optimal node location in the building 110 and an optimal node type, which the processor 206 may determine based on the correlation of the user inputs with the information associated with the electrical standard code, as described above.

In some aspects, as shown in FIG. 12B, when the first start location is same as the second start location, the second conduit segment 1214 may connect the first start point 1204 with the node “A” (or the determined optimal node location), and may be configured to house portions (e.g., first portions) of the first and second cables simultaneously from the first start point 1204 to the node “A”. Further, the third conduit segment 1216 may connect the node “A” (or the determined optimal node location) with the first end point 1206 when the first start location may be same as the second start location and when the first end location may be different from the second end location. In this case, the third conduit segment 1216 may house a second portion (or remaining portion) of the first cable. Furthermore, in this case, the fourth conduit segment 1218 may connect the node “A” (or the determined optimal node) location with the second end point 1212, and configured to house a second portion (or remaining portion) of the second cable.

Responsive to generating the second conduit system model as described above, the processor 206 may cause the system user interface to display the second conduit system model (similar to displaying the first conduit system model).

In some aspects, similar to the user 105 adding the second cable to an existing conduit system model (e.g., the first conduit system model), the user 105 may add a third cable to an existing conduit system model (e.g., the second conduit system model) in a manner similar to adding the second cable. In this case, the user inputs that the user 105 provides to the transceiver 204/processor 206 may include a third start location and a third end location associated with a third cable to be installed in the building 110, third cable attributes, third load characteristics and attributes associated with a third load located at the third end location, information associated with a third cable type, and/or the like. The processor 206 may obtain such user inputs associated with the third cable that the user 105 desires to add to the second conduit system model, from the transceiver 204.

Responsive to obtaining the user inputs described above, the processor 206 may determine/check whether the third cable type is same as the first and second cable types, based on the information associated with the third cable type. As described above, the processor 206 may cause the system user interface to display/output an error notification when the third cable type may be different from the first and second cable types.

On the other hand, responsive to determining that the third cable type may be same as the first and second cable types, the processor 206 may determine/check whether the third start location is same as at least one of the first start location or the second start location, or the third end location is same as at least one of the first end location or the second end location. The processor 206 may cause the system user interface to display an error notification when the third cable start and end locations may not have any commonalities with the first and second start and end locations. On the other hand, the processor 206 may modify the second conduit system model to generate a third conduit system model configured to house the first cable, the second cable and the third cable, when the processor 206 determines that the third start location is same as at least one of the first start location or the second start location, or the third end location is same as at least one of the first end location or second end location. In some aspects, the processor 206 may generate the third conduit system model based on the first, second and third start locations, the first, second and third end locations, the first, second and third cable attributes, the first, second and third cable types, the first, second and third load characteristics and attributes, and the information associated with the electrical standard code (e.g., the NEC), as described above.

In some aspects, the third conduit system model may be same as the second conduit system model when the third start location may be same as at least one of the first start location or the second start location, and the third end location may be same as at least one of the first end location or second end location. In this case, the second conduit system model may house the third cable, without requiring to add any new node or any new conduit segment. For example, as shown in FIG. 12B, a third cable 1220 may be housed in the existing second conduit segment 1214 and the third conduit segment 1216, when the third start location may be same as the first start point 1204 and the third end location may be same as the first end point 1206. In this case, the processor 206 may not modify the second conduit system model to generate a new third conduit system model, since the existing conduit segments associated with the second conduit system model may house the third cable 1220.

A different scenario is depicted in FIG. 12C, where the third start location may be same as the first end point 1206 and the third end location may be same as the second end point 1212. In this case also, the processor 206 may not modify the second conduit system model to generate a new third conduit system model, since the existing conduit segments associated with the second conduit system model may house the third cable 1220. In this exemplary aspect, the third conduit segment 1216 and the fourth conduit segment 1218 may house the third cable 1220.

Yet another scenario is depicted in FIG. 12D, where the third start location may be same as the first start point 1204, however, a third end location 1222 may be different from the first end point 1206 and the second end point 1212 (not shown in FIG. 12D). In this case, the processor 206 may generate a new third conduit system model having a third schematic diagram 1224, as shown in FIG. 12D. In this case, a first portion of the third cable may be housed in the second conduit segment 1214, and a second (or remaining portion) of the third cable may be housed in a fifth conduit segment 1226 that may connect the node “A” with the third end location 1222.

Yet another scenario is depicted in FIG. 12E, where the third start location may be same as the first end point 1206, however, the third end location 1222 may be different from the first start location, and the second start and end locations. In this case, the processor 206 may generate a new third conduit system model having a fourth schematic diagram 1228, as shown in FIG. 12E. In this exemplary aspect, a first portion of the third cable may be housed in the third conduit segment 1216 (that may also house the second portion of the first cable), and a second (or remaining portion) of the third cable may be housed in the fifth conduit segment 1226 that may connect the node “A” with the third end location 1222.

Yet another scenario is depicted in FIG. 12F, where the third start location may be same as the first end point 1206, and the third end location 1222 may be different from the first start location, and the second start and end locations. In this case, the processor 206 may generate a new third conduit system model having a fifth schematic diagram 1230, as shown in FIG. 12F. In this exemplary aspect, the second conduit segment 1214 may house the first portion of the first cable from the first start point 1204 to the node “A”, and the third conduit segment 1216 may house the second portion of the first cable from the node “A” to the first end point 1206. Further, the first portion of the second cable may be housed in the second conduit segment 1214 from the first start point 1204 to the node “A”. Further, the second portion of the second cable may be housed in a new sixth conduit segment 1232 that connects the node “A” with a new node “B”. Furthermore, a third (and remaining) portion of the second cable may be housed in a new seventh conduit segment 1234 that connects the node “B” with the second end point 1212.

In addition, a first portion of the third cable may be housed in the third conduit segment 1216, a second portion of the third cable may be housed in the sixth conduit segment 1232, and a third (and remaining portion) of the third cable may be housed in a new eighth conduit segment 1236 that connects the node “B” with the third end location 1222.

The example scenarios depicted in FIGS. 12A-12F and described above should not be construed as limiting. The processor 206 may create a plurality of different types of conduit system models, based on different types of user inputs provided by the user 105 to the system 200.

Responsive to generating the third conduit system model as described above, the processor 206 may cause the system user interface to display the third conduit system model, including the schematic diagram or riser diagram or circuit diagram associated with the third conduit system model, and characteristics and attributes associated with the different conduit segments, nodes, etc., which may be part of the third conduit system model. The processor 206 may also automatically create bill of material or schedule for the conduit segments, nodes, etc., based on the generated conduit system model, as described above. The created bill of material or schedule may be displayed on the system user interface, or transmitted (via the transceiver 204) to a plurality of user devices associated with third-party vendors (along with transmitting the generated conduit system model(s)).

In further aspects, responsive to generating a plurality of conduit system models in the manner described above, the processor 206 may be configured to combine the plurality of conduit system models together to create/generate a consolidated riser diagram 1300 of the electrical installation project for the building 110, as shown in FIG. 13. The riser diagram 1300 may integrate or consolidate a plurality of different conduit system models (shown as models 1302a, 1302b, 1302n in FIG. 13) together. A person ordinarily skilled in the art may appreciate that manually creating a consolidated riser diagram may be a time consuming task for the user 105, and may cause inconvenience to the user 105. The processor 206 automatically consolidates all the conduit system models generated for the building 110 to create the riser diagram 1300.

Responsive to creating the riser diagram 1300, the processor 206 may cause the system user interface to display the riser diagram 1300. The user 105 may analyze the consolidated riser diagram 1300, or may transmit the riser diagram 1300 to third-party experts for opinion/consultation, or to vendors for quotes/bids. In further aspects, the user 105 may update any of the conduit system models 1302a, 1302b, 1302n by clicking on the riser diagram 1300, and updating the corresponding load or cable or conduit characteristics or attributes, to cause automatic and dynamic update of the riser diagram 1300, as described above. A person ordinarily skilled in the art may appreciate that manually updating a consolidated riser diagram for a building may be a time consuming task. The system 200 enables the user 105 to update the riser diagram 1300 by simply clicking on the relevant conduit system model to be updated, thereby enabling the user 105 to conveniently and quickly update the riser diagram 1300.

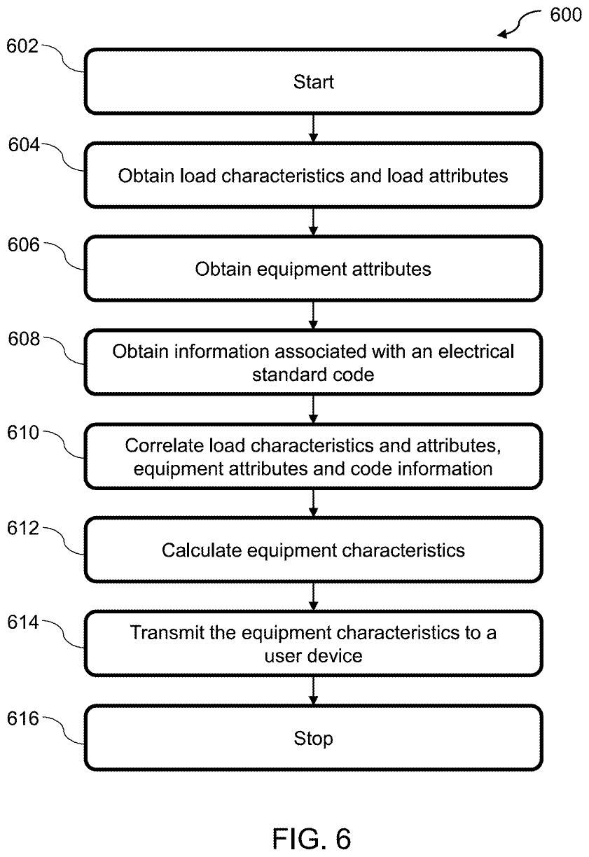

FIG. 6 depicts a flow diagram of an example method 600 to facilitate the user 105 in building an electrical installation model in accordance with the present disclosure. FIG. 6 may be described with continued reference to prior figures, including FIGS. 1-5. The following process is exemplary and not confined to the steps described hereafter. Moreover, alternative embodiments may include more or less steps that are shown or described herein and may include these steps in a different order than the order described in the following example embodiments.

Referring to FIG. 6, at step 602, the method 600 may commence. At step 604, the method 600 may include obtaining, by the processor 206, the load characteristics and the load attributes associated with the plurality of loads to be installed in the building 110. At step 606, the method 600 may include obtaining, by the processor 206, the equipment attributes as described above in conjunction with FIG. 2. At step 608, the method 600 may include obtaining, by the processor 206, the information associated with the electrical standard code, e.g., the NEC.

Responsive to obtaining the information described above, at step 610, the processor 206 may correlate the load characteristics, the load attributes, the equipment attributes and the information associated with the electrical standard code, as described above. At step 612, the method 600 may include calculating, by the processor 206, the equipment characteristics based on the correlation. At step 614, the method 600 may include transmitting, by the processor 206 via the transceiver 204, the equipment characteristics to the user device 115.

At step 616, the method 600 may stop.

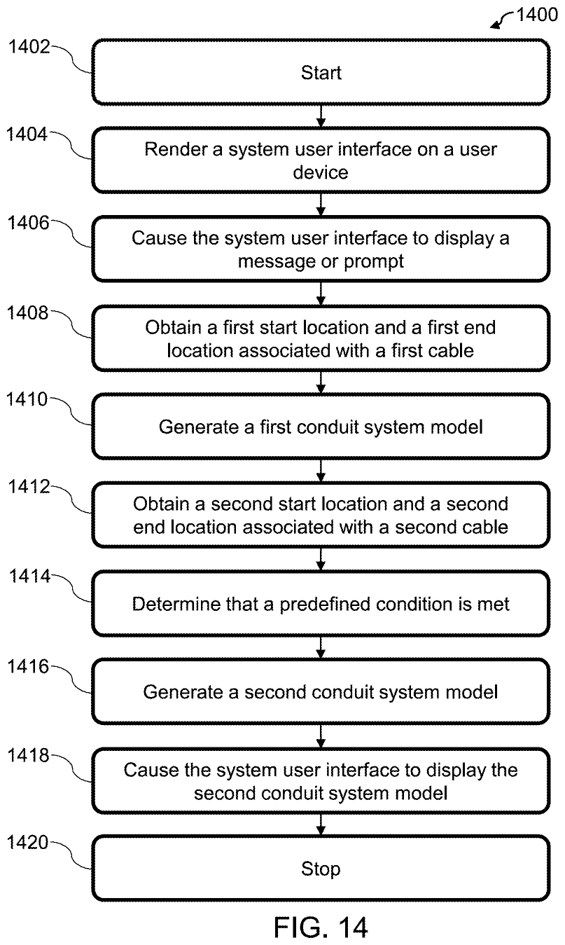

FIG. 14 depicts a flow diagram of an example conduit design generation method 1400 in accordance with the present disclosure. FIG. 14 may be described with continued reference to prior figures. The following process is exemplary and not confined to the steps described hereafter. Moreover, alternative embodiments may include more or less steps than are shown or described herein and may include these steps in a different order than the order described in the following example embodiments.

At step 1402, the method 1400 may commence. At step 1404, the method 1400 may include rendering, by the processor 206, the system user interface on the user device 115 associated with the user 105. At step 1406, the method 1400 may include causing, by the processor 206, the system user interface to display a message/prompt requesting the user 105 to perform a predefined action on the system user interface, responsive to rendering the system user interface on the user device 115.

At step 1408, the method 1400 may include obtaining, by the processor 206, the first start location and the first end location associated with the first cable to be installed in the building 110 from the user 105 via the system user interface, responsive to causing the system user interface to display the message/prompt. At step 1410, the method 1400 may include generating, by the processor 206, the first conduit system model configured to house the first cable based on the first start location, the first end location, and the information associated with an electrical standard code.

At step 1412, the method 1400 may include obtaining, by the processor 206, the second start location and the second end location associated with the second cable to be installed in the building 110 from the user 105 via the system user interface, responsive to generating the first conduit system model. At step 1414, the method 1400 may include determining, by the processor 206, that a predefined condition is met. Specifically, the processor 206 may determine that at least one of the first start location is same as the second start location or the first end location is same as the second end location.

At step 1416, the method 1400 may include generating, by the processor 206, the second conduit system model configured to house the first cable and the second cable based on the first start location, the first end location, the second start location, the second end location and the information associated with the electrical standard code, responsive to the determination described above. At step 1418, the method 1400 may include causing, by the processor 206, the system user interface to display the second conduit system model.

At step 1420, the method 1400 may end.

In the above disclosure, reference has been made to the accompanying drawings, which form a part hereof, which illustrate specific implementations in which the present disclosure may be practiced. It is understood that other implementations may be utilized, and structural changes may be made without departing from the scope of the present disclosure. References in the specification to “one embodiment,” “an embodiment,” “an example embodiment,” etc., indicate that the embodiment described may include a particular feature, structure, or characteristic, but every embodiment may not necessarily include the particular feature, structure, or characteristic. Moreover, such phrases are not necessarily referring to the same embodiment. Further, when a feature, structure, or characteristic is described in connection with an embodiment, one skilled in the art will recognize such feature, structure, or characteristic in connection with other embodiments whether or not explicitly described.

Further, where appropriate, the functions described herein can be performed in one or more of hardware, software, firmware, digital components, or analog components. For example, one or more application specific integrated circuits (ASICs) can be programmed to carry out one or more of the systems and procedures described herein. Certain terms are used throughout the description and claims refer to particular system components. As one skilled in the art will appreciate, components may be referred to by different names. This document does not intend to distinguish between components that differ in name, but not function.

It should also be understood that the word “example” as used herein is intended to be non-exclusionary and non-limiting in nature. More particularly, the word “example” as used herein indicates one among several examples, and it should be understood that no undue emphasis or preference is being directed to the particular example being described.

A computer-readable medium (also referred to as a processor-readable medium) includes any non-transitory (e.g., tangible) medium that participates in providing data (e.g., instructions) that may be read by a computer (e.g., by a processor of a computer). Such a medium may take many forms, including, but not limited to, non-volatile media and volatile media. Computing devices may include computer-executable instructions, where the instructions may be executable by one or more computing devices such as those listed above and stored on a computer-readable medium.

With regard to the processes, systems, methods, heuristics, etc. described herein, it should be understood that, although the steps of such processes, etc. have been described as occurring according to a certain ordered sequence, such processes could be practiced with the described steps performed in an order other than the order described herein. It further should be understood that certain steps could be performed simultaneously, that other steps could be added, or that certain steps described herein could be omitted. In other words, the descriptions of processes herein are provided for the purpose of illustrating various embodiments and should in no way be construed so as to limit the claims.

Accordingly, it is to be understood that the above description is intended to be illustrative and not restrictive. Many embodiments and applications other than the examples provided would be apparent upon reading the above description. The scope should be determined, not with reference to the above description, but should instead be determined with reference to the appended claims, along with the full scope of equivalents to which such claims are entitled. It is anticipated and intended that future developments will occur in the technologies discussed herein, and that the disclosed systems and methods will be incorporated into such future embodiments. In sum, it should be understood that the application is capable of modification and variation.

All terms used in the claims are intended to be given their ordinary meanings as understood by those knowledgeable in the technologies described herein unless an explicit indication to the contrary is made herein. In particular, use of the singular articles such as “a,” “the,” “said,” etc. should be read to recite one or more of the indicated elements unless a claim recites an explicit limitation to the contrary. Conditional language, such as, among others, “can,” “could,” “might,” or “may,” unless specifically stated otherwise, or otherwise understood within the context as used, is generally intended to convey that certain embodiments could include, while other embodiments may not include, certain features, elements, and/or steps. Thus, such conditional language is not generally intended to imply that features, elements, and/or steps are in any way required for one or more embodiments.

That which is claimed is:

1. A conduit design generation system comprising:
a transceiver configured to receive user inputs from a user via a system user interface rendered on a user device, wherein the user inputs comprise:
a first start location and a first end location associated with a first cable to be installed in a building, and
a second start location and a second end location associated with a second cable to be installed in the building;
a memory configured to store information associated with an electrical standard code; and
a processor communicatively coupled with the memory and the transceiver, wherein the processor is configured to:
render the system user interface on the user device;
cause the system user interface to display a message requesting the user to perform a predefined action on the system user interface, responsive to rendering the system user interface on the user device;
obtain the first start location and the first end location from the transceiver, responsive to causing the system user interface to display the message;
generate a first conduit system model configured to house the first cable based on the first start location, the first end location, and the information associated with the electrical standard code;
obtain the second start location and the second end location from the transceiver, responsive to generating the first conduit system model;
determine that at least one of the first start location is same as the second start location or the first end location is same as the second end location;
generate a second conduit system model configured to house the first cable and the second cable based on the first start location, the first end location, the second start location, the second end location and the information associated with the electrical standard code, responsive to the determination; and
cause the system user interface to display the second conduit system model.

2. The conduit design generation system of claim 1, wherein the user inputs further comprise information associated with a first cable type and a second cable type, and wherein the processor is further configured to:
determine that the first cable type is same as the second cable type based on the information associated with the first cable type and the second cable type; and
generate the second conduit system model responsive to determining that the first cable type is same as the second cable type.

3. The conduit design generation system of claim 2, wherein the processor is further configured to:
determine that the first cable type is not same as the second cable type based on the information associated with the first cable type and the second cable type; and
cause the system user interface to display a first error notification responsive to determining that the first cable type is not same as the second cable type.

4. The conduit design generation system of claim 1, wherein the first conduit system model comprises first segment characteristics associated with a first conduit segment configured to house the first cable from the first start location to the first end location and a first schematic diagram of the first conduit segment connecting the first start location and the first end location, and wherein the processor is further configured to cause the system user interface to display the first conduit system model.

5. The conduit design generation system of claim 4, wherein the first segment characteristics comprise information associated with one or more of a first segment material, a maximum permissible first segment fill limit percentage, a first segment length, first segment dimensions, and a first segment type.

6. The conduit design generation system of claim 4, wherein the second conduit system model is same as the first conduit system model when the first start location is same as the second start location and the first end location is same as the second end location, and wherein the first conduit segment is configured to house the first cable and the second cable simultaneously when the first start location is same as the second start location and the first end location is same as the second end location.

7. The conduit design generation system of claim 1, wherein the second conduit system model is different from the first conduit system model when the first start location is different from the second start location or the first end location is different from the second end location.

8. The conduit design generation system of claim 7, wherein the second conduit system model comprises second segment characteristics associated with a second conduit segment, node characteristics associated with a node, third segment characteristics associated with a third conduit segment, fourth segment characteristics associated with a fourth conduit segment, and a second schematic diagram connecting the second conduit segment, the third conduit segment, the fourth conduit segment and the node.

9. The conduit design generation system of claim 8, wherein:
each of the second segment characteristics, the third segment characteristics and the fourth segment characteristics comprises one or more of a segment material, a maximum permissible segment fill limit percentage, a segment length, segment dimensions, and a segment type;
the node characteristics comprise an optimal node location in the building and a node type;
the second conduit segment connects the first start location with the optimal node location when the first start location is same as the second start location;
the second conduit segment is configured to house a first portion of the first cable and a first portion of the second cable simultaneously;
the third conduit segment connects the optimal node location with the first end location when the first start location is same as the second start location and when the first end location is different from the second end location;
the third conduit segment is configured to house a second portion of the first cable;
the fourth conduit segment connects the optimal node location with the second end location; and
the fourth conduit segment is configured to house a second portion of the second cable.

10. The conduit design generation system of claim 9, wherein the user inputs further comprise:
a third start location and a third end location associated with a third cable to be installed in the building; and
information associated with a third cable type.

11. The conduit design generation system of claim 10, wherein the processor is further configured to:
determine that the third cable type is same as a first cable type and a second cable type;
determine that the third start location is same as at least one of the first start location or the second start location, or the third end location is same as at least one of the first end location or the second end location, responsive to determining that the third cable type is same as the first cable type and the second cable type;
generate a third conduit system model configured to house the first cable, the second cable and the third cable, based on the first start location, the second start location, the third start location, the first end location, the second end location, the third end location and the information associated with the electrical standard code, responsive to the determination; and
cause the system user interface to display the third conduit system model.

12. The conduit design generation system of claim 11, wherein the third conduit system model is same as the second conduit system model when the third start location is same as at least one of the first start location or the second start location, and the third end location is same as at least one of the first end location or the second end location.

13. The conduit design generation system of claim 1, wherein:
the first start location and the second start location are associated with at least one of a load control center or a cable tray installed in the building,
the first end location is associated with a first load location of a first load installed in the building, and
the second end location is associated with a second load location of a second load installed in the building.

14. The conduit design generation system of claim 13, wherein the user inputs further comprise first load characteristics and attributes, second load characteristics and attributes, first cable attributes, and second cable attributes, and wherein the processor is further configured to generate the first conduit system model and the second conduit system model based on the user inputs.

15. The conduit design generation system of claim 1, wherein the processor is further configured to:
generate a second error notification when neither the first start location is same as the second start location nor the first end location is same as the second end location; and
cause the system user interface to display the second error notification.

16. The conduit design generation system of claim 1, wherein the processor is further configured to:
determine that the user has created a new electrical installation project instance on the conduit design generation system, responsive to rendering the system user interface on the user device; and
cause the system user interface to display the message requesting the user to perform the predefined action on the system user interface, responsive to determining that the user has created the new electrical installation project instance,
wherein the transceiver receives the user inputs from the user when the user performs the predefined action on the system user interface.

17. The conduit design generation system of claim 16, wherein the predefined action comprises typing the user inputs on the system user interface via a user device touchscreen.

18. The conduit design generation system of claim 16, wherein the system user interface comprises a plurality of preset icons associated with at least one of loads or cables, wherein the plurality of preset icons are located at a first predefined location on the system user interface, and wherein the predefined action comprises at least one of:
selecting or clicking one or more icons, from the plurality of preset icons, on the system user interface; or
dragging one or more icons, from the plurality of preset icons, from the first predefined location on the system user interface to a second predefined location on the system user interface.

19. A conduit design generation method comprising:
rendering, by a processor, a system user interface on a user device associated with a user;
causing, by the processor, the system user interface to display a message requesting the user to perform a predefined action on the system user interface, responsive to rendering the system user interface on the user device;
obtaining, by the processor, a first start location and a first end location associated with a first cable to be installed in a building from the user via the system user interface, responsive to causing the system user interface to display the message;
generating, by the processor, a first conduit system model configured to house the first cable based on the first start location, the first end location, and information associated with an electrical standard code;
obtaining, by the processor, a second start location and a second end location associated with a second cable to be installed in the building from the user via the system user interface, responsive to generating the first conduit system model;
determining, by the processor, that at least one of the first start location is same as the second start location or the first end location is same as the second end location;
generating, by the processor, a second conduit system model configured to house the first cable and the second cable based on the first start location, the first end location, the second start location, the second end location and the information associated with the electrical standard code, responsive to the determination; and
causing, by the processor, the system user interface to display the second conduit system model.

20. A non-transitory computer-readable storage medium in a distributed computing system, the non-transitory computer-readable storage medium having instructions stored thereupon which, when executed by a processor, cause the processor to:
render a system user interface on a user device associated with a user;
cause the system user interface to display a message requesting the user to perform a predefined action on the system user interface, responsive to rendering the system user interface on the user device;
obtain a first start location and a first end location associated with a first cable to be installed in a building from the user via the system user interface, responsive to causing the system user interface to display the message;
generate a first conduit system model configured to house the first cable based on the first start location, the first end location, and information associated with an electrical standard code;
obtain a second start location and a second end location associated with a second cable to be installed in the building from the user via the system user interface, responsive to generating the first conduit system model;
determine that at least one of the first start location is same as the second start location or the first end location is same as the second end location;
generate a second conduit system model configured to house the first cable and the second cable based on the first start location, the first end location, the second start location, the second end location and the information associated with the electrical standard code, responsive to the determination; and
cause the system user interface to display the second conduit system model.
